(19) United States
(12) Patent Application Publication
(10) Pub. No.: US 2009/0172669 A1
(43) Pub. Date: Jul. 2, 2009

(54) USE OF REDUNDANCY GROUPS IN RUNTIME COMPUTER MANAGEMENT OF BUSINESS APPLICATIONS

(75) Inventors: Mythili K. Bobak, Lagrangeville, NY (US); Chun-Shi Chang, Poughkeepsie, NY (US); Tim A. McConnell, Lexington, KY (US); Michael D. Swanson, Springfield, OR (US)

Correspondence Address: HESLIN ROTHENBERG FARLEY & MESITI P.C., 5 COLUMBIA CIRCLE, ALBANY, NY, 12203, US

(73) Assignee: INTERNATIONAL BUSINESS MACHINES CORPORATION, Armonk, NY (US)

(21) Appl. No.: 11/965,877

(22) Filed: Dec. 28, 2007

(51) Int. Cl. G06F 9/46

(52) U.S. Cl. 718/100

(57) ABSTRACT

A Redundancy Group includes one or more functionally equivalent resources, and is employed in the dynamic reconfiguration of resources. This enables a business application associated with the resources to be actively managed during runtime.

### TECHNICAL FIELD

This invention relates, in general, to managing customer environments to provide support for business resiliency, and in particular, to grouping resources to enable granular management of a customer's environment.

### BACKGROUND OF THE INVENTION

Today, customers attempt to manually manage and align their availability management with their information technology (IT) infrastructure. Changes in either business needs or the underlying infrastructure are often not captured in a timely manner and require considerable rework, leading to an inflexible environment.

Often high availability solutions and disaster recovery technologies are handled via a number of disparate point products that target specific scopes of failure, platforms or applications. Integrating these solutions into an end-to-end solution is a complex task left to the customer, with results being either proprietary and very specific, or unsuccessful.

Customers do not have the tools and infrastructure in place to customize their availability management infrastructure to respond to failures in a way that allows for a more graceful degradation of their environments. As a result, more drastic and costly actions may be taken (such as a site switch) when other options (such as disabling a set of applications or users) could have been offered, depending on business needs.

Coordination across availability management and other systems management disciplines is either nonexistent or accomplished via non-reusable, proprietary, custom technology.

There is little predictability as to whether the desired recovery objective will be achieved, prior to time of failure. There are only manual, labor intensive techniques to connect recovery actions with the business impact of failures and degradations.

Any change in the underlying application, technologies, business recovery objectives, resources or their interrelationships require a manual assessment of impact to the hand-crafted recovery scheme.

### SUMMARY OF THE INVENTION

Based on the foregoing, a need exists for a capability that facilitates active management of business applications during runtime. As an example, a need exists for a facility that optimizes, during runtime, the reconfiguration of resources to meet a particular goal, such as an availability goal or other goal.

The shortcomings of the prior art are overcome and additional advantages are provided through the provision of a computer-implemented method, in which a redundancy group including one or more functionally equivalent resources of a particular type is obtained; and during runtime and in response to an occurrence of an event, there is dynamic evaluation of which resource of a plurality of resources of the redundancy group is to be used as a target for an operation to be performed.

Computer program products and systems relating to one or more aspects of the present invention are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a processing environment to incorporate and use one or more aspects of the present invention;

FIG. 2 depicts another embodiment of a processing environment to incorporate and use one or more aspects of the present invention;

FIG. 3 depicts yet a further embodiment of a processing environment to incorporate and use one or more aspects of the present invention;

FIG. 4 depicts one embodiment of a Business Resilience System used in accordance with an aspect of the present invention;

FIG. 5A depicts one example of a screen display of a business resilience perspective, in accordance with an aspect of the present invention;

FIG. 5B depicts one example of a screen display of a Recovery Segment, in accordance with an aspect of the present invention;

FIG. 6A depicts one example of a notification view indicating a plurality of notifications, in accordance with an aspect of the present invention;

FIG. 6B depicts one example of a notification message sent to a user, in accordance with an aspect of the present invention;

FIG. 7 depicts one example of a Recovery Segment of the Business Resilience System of FIG. 4, in accordance with an aspect of the present invention;

FIG. 8A depicts examples of key Recovery Time Objective properties for a particular resource, in accordance with an aspect of the present invention;

FIG. 8B depicts one example in which Recovery Time Objective properties collectively form an observation of a Pattern System Environment, in accordance with an aspect of the present invention;

FIGS. 9A-9B depict one embodiment of the logic to create or update a Redundancy Group, in accordance with an aspect of the present invention;

FIG. 10 depicts examples of Redundancy Groups, in accordance with an aspect of the present invention;

FIG. 11 depicts one embodiment of the logic to define a Redundancy Group aggregated state, in accordance with an aspect of the present invention;

FIGS. 12A-12B depict one embodiment of the logic to manage responses to polling for resources, in accordance with an aspect of the present invention;

FIGS. 13A-13B depict one embodiment of the logic to update a Redundancy Group, as well as a Recovery Segment, in response to a query, in accordance with an aspect of the present invention;

FIGS. 14A-14P depict one embodiment of the logic to select a resource from a Redundancy Group to be used as a target for an operation that is to start a component, in accordance with an aspect of the present invention;

FIGS. 15A-15H depict further logic used in the selection of a target for an operation that is to start a component, in accordance with an aspect of the present invention;

FIGS. 16A-16C depict one embodiment of the logic to assign a selected target to an operation, in accordance with an aspect of the present invention; and

FIG. 17 depicts one embodiment of a computer program product incorporating one or more aspects of the present invention.

### DETAILED DESCRIPTION OF THE INVENTION

In managing a customer's environment, such as its business environment, there is a set of requirements unaddressed by existing technology, which causes unpredictable down time, large impact failures and recoveries, and significant extra labor cost, with resulting loss of business revenue. These requirements include, for instance:
1. Ensuring that there is a consistent recovery scheme across the environment, linked to the business application, across the different types of resources; not a different methodology performed by platform silo. The recovery is to match the scope of the business application, not limited in scope to a single platform. The recovery is to be end-to-end and allow for interaction across multiple vendor products. In one example, a business application is defined as a process that is supported by IT services. It is supportive of the products and/or services created by a customer. It can be of fine granularity (e.g., a specific service/product provided) or of coarse granularity (e.g., a group of services/products provided).
2. Ability to group together mixed resource types (servers, storage, applications, subsystems, network, etc.) into logical groupings aligned with business processes requirements for availability.
3. Ability to share resources across logical groups of resources; ability to nest these logical group definitions, with specifications for goal policy accepted and implemented at each level.
4. Pre-specified recommendations for resource groupings, with customization possible, and pattern matching customer configuration with vendor or customer provided groupings/relationships—to avoid requiring customers to start from scratch for definitions.
5. Ability to group together redundant resources with functional equivalence—use during validation when customer has less redundancy than required to meet the Recovery Time Objective (RTO) goal; in recovery to select an alternate resource for one that has failed.
6. Ability to configure the definition of what constitutes available, degraded, or unavailable based on customer's own sensitivity for a given grouping of resources, and business needs, and further aggregate the state across various resources to produce an overall state for the business application. The state is to be assessed real time, based on what is actually occurring in the system at the time, rather than fixed definitions. In some cases, a performance slowdown might flag a degraded environment, and in other cases, a failure may be necessary before flagging a degraded or unavailable environment. The definitions of available, degraded and unavailable are to be consumed by an availability system that evaluates them in the context of a policy, and then determines appropriate action, including possibly launching recovery automatically.
7. Ability to relate the redundancy capability of relevant resources to the availability status of a business application.
8. Allow customers to configure when recovery actions can be delegated to lower level resources, particularly since resource sharing is becoming more relevant in many customer environments.
9. Include customer or vendor best practices for availability as prespecified workflows, expressed in a standards based manner, that can be customized.
10. Ability to specify quantitative business goals for the recovery of logical groupings of resources, effecting both how the resources are pre-configured for recovery, as well as recovered during errors. One such quantitative goal is Recovery Time Objective (RTO). As part of the specification of quantitative business goals, to be able to include time bias of applications, and facilitate the encoding of appropriate regulatory requirements for handling of certain workloads during changing business cycles in selected businesses, such as financial services.
11. Decomposition of the overall quantified RTO goal to nested logical groups; processing for shared groups having different goals.
12. Ability to configure redundancy groupings and co-location requirements with resources from other vendors, using a representation for resources (which may be, for example, standards based), with ability to clearly identify the vendor as part of the resource definition.
13. Ability to use customer's own historical system measures to automatically generate various system environments, then use these system environments when specifying quantitative recovery goals (since recovery time achievability and requirements are not consistent across time of day, business cycle, etc.). The function is to be able to incorporate historical information from dependent resources, as part of the automatic generation of system environments.
14. Specification of statistical thresholds for acceptability of using historical information; customer specification directly of expected operation times and directive to use customer specified values.
15. Environments are matched to IT operations and time of day, with automatic processing under a new system environment at time boundaries—no automatic internal adjustment of RTO is to be allowed, rather changed if the customer has specified that a different RTO is needed for different system environments.
16. Goal Validation—Prior to failure time. Ability to see assessment of achievable recovery time, in, for instance, a Gantt chart like manner, detailing what is achievable for each resource and taking into account overlaps of recovery sequences, and differentiating by system environment. Specific use can be during risk assessments, management requests for additional recovery related resources, mitigation plans for where there are potentials for RTO miss. Example customer questions:
   What is my expected recovery time for a given application during “end of month close” system environment?
   What is the longest component of that recovery time?
   Can I expect to achieve the desired RTO during the “market open” for stock exchange or financial services applications?
   What would be the optimal sequence and parallelization of recovery for the resources used by my business application?
17. Ability to prepare the environment to meet the desired quantitative business goals, allowing for tradeoffs when shared resources are involved. Ensure that both automated and non-automated tasks can be incorporated into the pre-conditioning. Example of customer question: What would I need to do for pre-conditioning my system to support the RTO goal I need to achieve for this business application?
18. Ability to incorporate operations from any vendors' resources for pre-conditioning or recovery workflows, including specification of which pre-conditioning operations have effect on recoveries, which operations have dependencies on others, either within vendor resources or across resources from multiple vendors.
19. Customer ability to modify pre-conditioning workflows, consistent with supported operations on resources.
20. Ability to undo pre-conditioning actions taken, when there is a failure to complete a transactionally consistent set of pre-conditioning actions; recognize the failure, show customers the optional workflow to undo the actions taken, allow them to decide preferred technique for reacting to the failure—manual intervention, running undo set of operations, combination of both, etc.
21. Ability to divide pre-conditioning work between long running and immediate, nondisruptive short term actions.
22. Impact only the smallest set of resources required during recovery, to avoid negative residual or side effects for attempting to recover a broader set of resources than what is actually impacted by the failure.
23. Choosing recovery operations based on determination of which recovery actions address the minimal impact, to meet goal, and then prepare for subsequent escalation in event of failure of initial recovery actions.
24. Choosing a target for applications and operating systems (OS), based on customer co-location specifications, redundancy groups, and realtime system state.
25. Ability for customer to indicate specific effect that recovery of a given business process can have on another business process—to avoid situations where lower priority workloads are recovered causing disruption to higher priority workloads; handling situations where resources are shared.
26. Ability to prioritize ongoing recovery processing over configuration changes to an availability system, and over any other administration functions required for the availability system.
27. Ability for recoveries and pre-conditioning actions to run as entire transactions so that partial results are appropriately accounted for and backed out or compensated, based on actual effect (e.g., during recovery time or even pre-conditioning, not all actions may succeed, so need to preserve a consistent environment).
28. Allow for possible non-responsive resources or underlying infrastructure that does not have known maximum delays in response time in determining recovery actions, while not going beyond the allotted recovery time.
29. Allow customer to change quantified business recovery goals/targets without disruption to the existing recovery capability, with appropriate labeling of version of the policy to facilitate interaction with change management systems.
30. Allow customers to change logical groupings of resources that have assigned recovery goals, without disruption to the existing recovery capability, with changes versioned to facilitate interaction with change management systems.
31. Ability to specify customizable human tasks, with time specifications that can be incorporated into the goal achievement validation so customers can understand the full time involved for a recovery and where focusing on IT and people time is critical to reducing RTO.
32. There is a requirement/desire to implement dynamically modified redundancy groupings for those resources which are high volume—automatic inclusion based on a specified set of characteristics and a matching criteria.
33. There is a requirement/desire to automatically add/delete resources from the logical resource groupings for sets of resources that are not needing individual assessment.

The above set of requirements is addressed, however, by a Business Resiliency (BR) Management System, of which one or more aspects of the present invention are included. The Business Resiliency Management System provides, for instance:
1. Rapid identification of fault scope.
   a Correlation and identification of dependencies between business functions and the supporting IT resources.
   Impact analysis of failures affecting business functions, across resources used within the business functions, including the applications and data.
   Isolation of failure scope to smallest set of resources, to ensure that any disruptive recovery actions effect only the necessary resources.
2. Rapid granular and graceful degradation of IT service.
   Discontinuation of services based on business priorities.
   Selection of alternate resources at various levels may include selection of hardware, application software, data, etc.
   Notifications to allow applications to tailor or reduce service consumption during times of availability constraints.
3. Integration of availability management with normal business operations and other core business processes.
   Policy controls for availability and planned reconfiguration, aligned with business objectives.
   Encapsulation, integration of isolated point solutions into availability IT fabric, through identification of affected resources and operations initiated by the solutions, as well as business resiliency.
   Goal based policy support, associated with Recovery Segments that may be overlapped or nested in scope.
   Derivation of data currency requirements, based on business availability goals.

One goal of the BR system is to allow customers to align their supporting information technology systems with their business goals for handling failures of various scopes, and to offer a continuum of recovery services from finer grained process failures to broader scoped site outages. The BR system is built around the idea of identifying the components that constitute a business function, and identifying successive levels of recovery that lead to more complex constructs as the solution evolves. The various recovery options are connected by an overall BR management capability that is driven by policy controls.

Various characteristics of one embodiment of a BR system include:
1. Capability for dynamic generation of recovery actions, into a programmatic and manageable entity.
2. Dynamic generation of configuration changes required/desired to support a customer defined Recovery Time Objective (RTO) goal.
3. Dynamic definition of key Pattern System Environments (PSEs) through statistical analysis of historical observations.
4. Validation of whether requested RTO goals are achievable, based on observed historical snapshots of outages or customer specified recovery operation time duration, in the context of key Pattern System Environments.
5. BR system dynamic, automatic generation and use of standards based Business Process Execution Language (BPEL) workflows to specify recovery transactions and allow for customer integration through workflow authoring tools.
6. Ability to configure customized scopes of recovery, based on topologies of resources and their relationships, called Recovery Segments (RSs).
7. Best practice workflows for configuration and recovery, including, but not limited to, those for different resource types: servers, storage, network, and middleware, as examples.
8. Ability to customize the definition of available, degraded, unavailable states for Recovery Segments.
9. Ability to represent customers' recommended configurations via best practice templates.
10. Ability to define the impact that recovery of one business application is allowed to have on other business applications.
11. Ability to correlate errors from the same or multiple resources into related outages and perform root cause analysis prior to initiating recovery actions.
12. Quantified policy driven, goal oriented management of unplanned outages.
13. Groupings of IT resources that have associated, consistent recovery policy and recovery actions, classified as Recovery Segments.
14. Handling of situations where the underlying error detection and notifications system itself is unavailable.

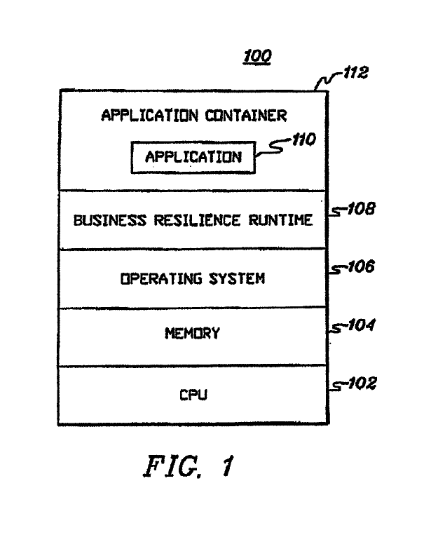

A Business Resilience System is capable of being incorporated in and used by many types of environments. One example of a processing environment to incorporate and use aspects of a BR system, including one or more aspects of the present invention, is described with reference to FIG. 1.

Processing environment 100 includes, for instance, a central processing unit (CPU) 102 coupled to memory 104 and executing an operating system 106. Examples of operating systems include AIX® and z/OS®, offered by International Business Machines Corporation; Linux; etc. AIX® and z/OS® are registered trademarks of International Business Machines Corporation, Armonk, N.Y., U.S.A. Other names used herein may be registered trademarks, trademarks or product names of International Business Machines Corporation or other companies.

The operating system manages execution of a Business Resilience Runtime Component 108 of a Business Resilience System, described herein, and one or more applications 10 of an application container 112.

As examples, processing environment 100 includes an IBM® System z™ processor or a pSeries® server offered by International Business Machines Corporation; a Linux server; or other servers, processors, etc. Processing environment 100 may include more, less and/or different components than described herein. (pSeries® is a registered trademark of International Business Machines Corporation, Armonk, N.Y., USA.)

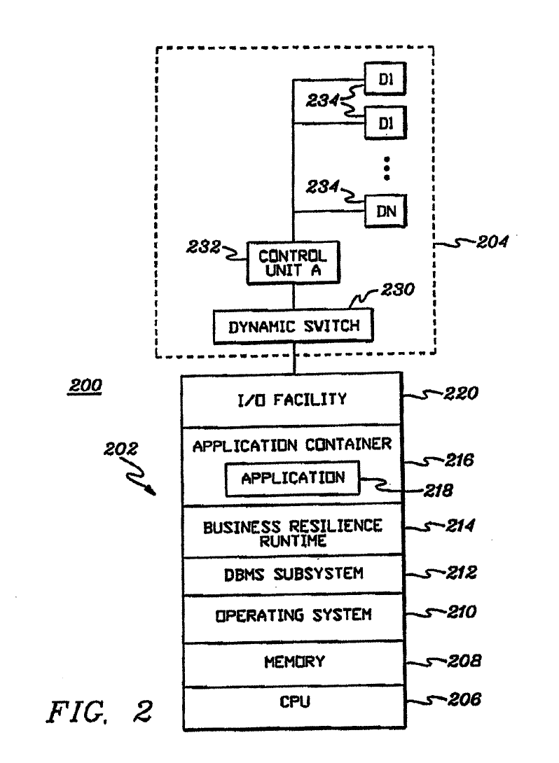

Another example of a processing environment to incorporate and use aspects of a BR System, including one or more aspects of the present invention, is described with reference to FIG. 2.

As shown, a processing environment 200 includes for instance, a central processing complex 202 coupled to an input/output (I/O) subsystem 204. Central processing complex 202 includes, for instance, a central processing unit 206, memory 208, an operating system 210, a database management system 212, a Business Resilience Runtime Component 214, an application container 216 including one or more applications 218, and an I/O facility 220.

I/O facility 220 couples central processing complex 202 to I/O subsystem 204 via, for example, a dynamic switch 230. Dynamic switch 230 is coupled to a control unit 232, which is further coupled to one or more I/O devices 234, such as one or more direct access storage devices (DASD).

Processing environments 100 and/or 200 may include, in other embodiments, more, less and/or different components.

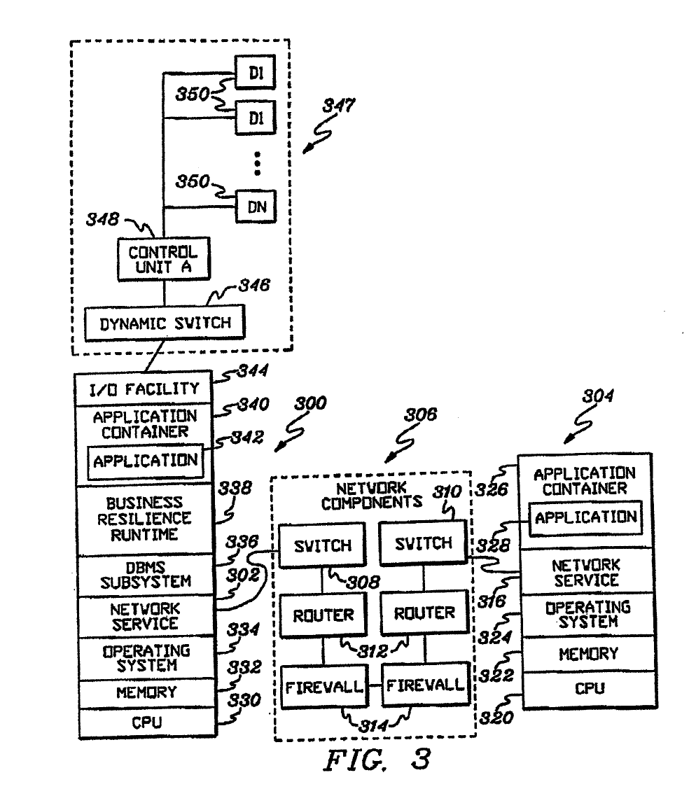

In yet another embodiment, a central processing complex 300 (FIG. 3) further includes a network service 302, which is used to couple a central processing complex 300 to a processing environment 304 via a network subsystem 306.

For example, network service 302 of central processing complex 300 is coupled to a switch 308 of network subsystem 306. Switch 308 is coupled to a switch 310 via routers 312 and firewalls 314. Switch 310 is further coupled to a network service 316 of processing environment 304.

Processing environment 304 further includes, for instance, a central processing unit 320, a memory 322, an operating system 324, and an application container 326 including one or more applications 328. In other embodiments, it can include more, less and/or different components.

Moreover, CPC 300 further includes, in one embodiment, a central processing unit 330, a memory 332, an operating system 334, a database management system 336, a Business Resilience Runtime Component 338, an application container 340 including one or more applications 342, and an I/O facility 344. It also may include more, less and/or different components.

I/O facility 344 is coupled to a dynamic switch 346 of an I/O subsystem 347. Dynamic switch 346 is further coupled to a control unit 348, which is coupled to one or more I/O devices 350.

Although examples of various environments are provided herein, these are only examples. Many variations to the above environments are possible and are considered within the scope of the present invention.

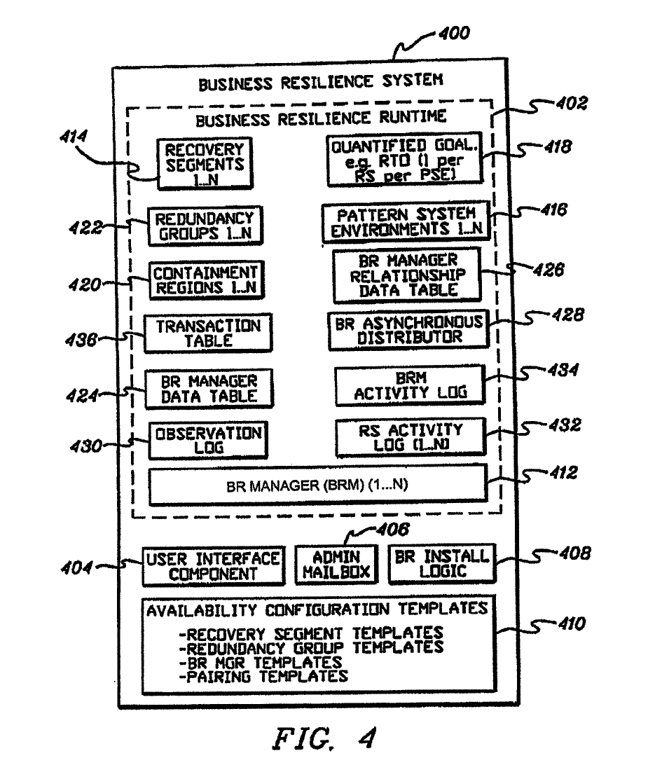

In the above-described environments, a Business Resilience Runtime Component of a Business Resilience System is included. Further details associated with a Business Resilience Runtime Component and a Business Resilience System are described with reference to FIG. 4.

In one example, a Business Resilience System 400 is a component that represents the management of recovery operations and configurations across an IT environment. Within that Business Resilience System, there is a Business Resilience Runtime Component (402) that represents the management functionality across multiple distinct Recovery Segments, and provides the service level automation and the support of creation of the recovery sequences. In addition, there are user interface (404), administration (406), installation (408) and configuration template (410) components within the Business Resilience System that enable the administrative operations that are to be performed. Each of these components is described in further detail below.

Business Resilience Runtime Component 402 includes a plurality of components of the BR System that are directly responsible for the collection of observations, creation of PSEs, policy acceptance, validation, error detection, and formulation of recovery sequences. As one example, Business Resilience Runtime Component 402 includes the following components:

1. One or more Business Resilience Managers (BRM) (412).
The Business Resilience Manager (BRM) is the primary component containing logic to detect potential errors in the IT environment, perform assessment to find resources causing errors, and formulate recovery sequences to reestablish the desired state for resources for all Recovery Segments that may be impacted.
The Business Resilience Manager is a component of which there can be one or more. It manages a set of Recovery Segments, and has primary responsibility to formulate recovery sequences. The association of which Recovery Segments are managed by a given BRM is determined at deployment time by the customer, with the help of deployment time templates. BRMs are primarily responsible for operations that relate to error handling and recovery workflow generation, and cross RS interaction.

2. One or more Recovery Segments (RS) (414).
Recovery Segments are customer-defined groupings of IT resources to which consistent availability policy is assigned. In other words, a Recovery Segment acts as a context within which resource recovery is performed. In many cases, Recovery Segments are compositions of IT resources that constitute logical entities, such as a middleware and its related physical resources, or an “application” and its related components.
There is no presumed granularity of a Recovery Segment. Customers can choose to specify fine-grained Recovery Segments, such as one for a given operating system, or a coarser grained Recovery Segment associated with a business process and its component parts, or even a site, as examples.
Relationships between IT resources associated with a RS are those which are part of the IT topology.
Recovery Segments can be nested or overlapped. In case of overlapping Recovery Segments, there can be policy associated with each RS, and during policy validation, conflicting definitions are reconciled. Runtime assessment is also used for policy tradeoff.
The Recovery Segment has operations which support policy expression, validation, decomposition, and assessment of state.
The number of Recovery Segments supported by a BR System can vary, depending on customer configurations and business needs.
One BRM can manage multiple Recovery Segments, but a given RS is managed by a single BRM. Further, Recovery Segments that share resources, or are subset/superset of other Recovery Segments are managed by the same BRM, in this example. Multiple BRMs can exist in the environment, depending on performance, availability, and/or maintainability characteristics.

3. Pattern System Environments (PSEs) (416).
Pattern System Environments (PSEs) are representations of a customer's environment. Sets of observations are clustered together using available mathematical tooling to generate the PSEs. In one embodiment, the generation of a PSE is automatic. A PSE is associated with a given RS, but a PSE may include information that crosses RSs.
As one example, the representation is programmatic in that it is contained within a structure from which information can be added/extracted.

4. Quantified Recovery Goal (418).
A quantified recovery goal, such as a Recovery Time Objective (RTO), is specified for each Recovery Segment that a customer creates. If customers have multiple Pattern System Environments (PSEs), a unique RTO for each PSE associated with the RS may be specified.

5. Containment Region (CR) (420).
Containment Region(s) are components of the BR System which are used at runtime to reflect the scope and impact of an outage. A Containment Region includes, for instance, identification for a set of impacted resources, as well as BR specific information about the failure/degraded state, as well as proposed recovery. CRs are associated with a set of impacted resources, and are dynamically constructed by BR in assessing the error.
The original resources reporting degraded availability, as well as the resources related to those reporting degraded availability, are identified as part of the Containment Region. Impacted resources are accumulated into the topology by traversing the IT relationships and inspecting the attributes defined to the relationships. The Containment Region is transitioned to an inactive state after a successful recovery workflow has completed, and after all information (or a selected subset in another example) about the CR has been logged.

6. Redundancy Groups (RG) (422).
Redundancy Group(s) (422) are components of the BR System that represent sets of logically equivalent services that can be used as alternates when a resource experiences failure or degradation. For example, three instances of a database may form a redundancy group, if an application server requires connectivity to one of the set of three, but does not specify one specific instance.
There can be zero or more Redundancy Groups in a BR System.
Redundancy Groups also have an associated state that is maintained in realtime, and can contribute to the definition of what constitutes available, degraded, or unavailable states. In addition, Redundancy Groups members are dynamically and automatically selected by the BR System, based on availability of the member and co-location constraints.

7. BR Manager Data Table (BRMD) (424).
BR maintains specific internal information related to various resources it manages and each entry in the BR specific Management Data (BRMD) table represents such a record of management. Entries in the BRMD represent IT resources.

8. BR Manager Relationship Data Table (BRRD) (426).
BR maintains BR specific internal information related to the pairings of resources it needs to interact with, and each entry in the BR specific Relationship Data (BRRD) table represents an instance of such a pairing. The pairing record identifies the resources that participate in the pairing, and resources can be any of those that appear in the BRMD above. The BRRD includes information about the pairings, which include operation ordering across resources, failure and degradation impact across resources, constraint specifications for allowable recovery actions, effect an operation has on resource state, requirements for resource to co-locate or anti-co-locate, and effects of preparatory actions on resources.

9. BR Asynchronous Distributor (BRAD) (428).
The BR Asynchronous Distributor (BRAD) is used to handle asynchronous behavior during time critical queries for resource state and key properties, recovery, and for getting observations back from resources for the observation log.

10. Observation Log (430).
The Observation Log captures the information that is returned through periodic observations of the environment. The information in the Observation Log is used by cluster tooling to generate Pattern System Environments (PSE).

11. RS Activity Log (432).
Each RS has an activity log that represents the RS actions, successes, failures. Activity logs are internal BR structures. Primarily, they are used for either problem determination purposes or at runtime, recovery of failed BR components. For example, when the RS fails and recovers, it reads the Activity Log to understand what was in progress at time of failure, and what needs to be handled in terms of residuals.

12. BRM Activity Log (434).
The BRM also has an activity log that represents BRM actions, success, failures. Activity logs are internal BR structures.

13. Transaction Table (TT) (436).
The transaction table is a serialization mechanism used to house the counts of ongoing recovery and preparatory operations. It is associated with the RS, and is referred to as the RS TT.

In addition to the Business Resilience Runtime Component of the BR system, the BR system includes the following components, previously mentioned above.

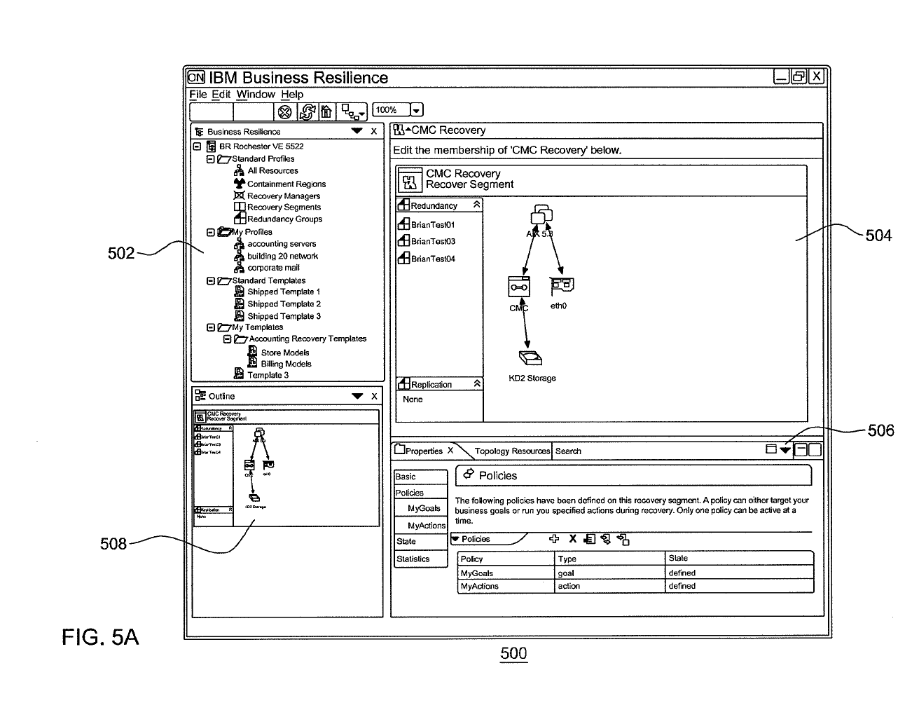

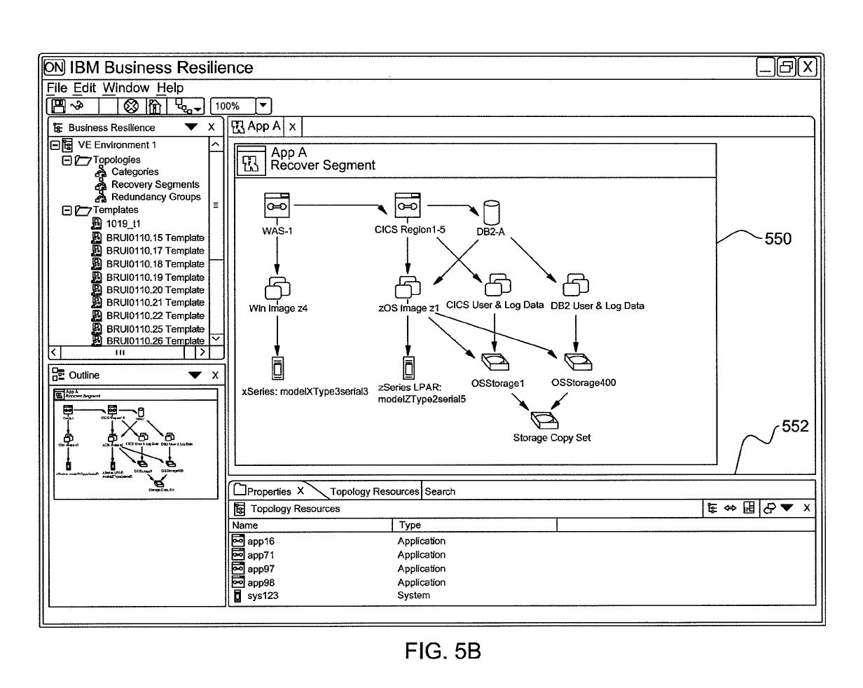

User Interface (UI) Component (404).
The User interface component is, for instance, a graphical environment through which the customer's IT staff can make changes to the BR configuration. As examples: create and manage Recovery Segments; specify recovery goals; validate achievability of goals prior to failure time; view and alter BR generated workflows.
The user interface (UI) is used as the primary interface for configuring BR. It targets roles normally associated with a Business Analyst, Solution Architect, System Architect, or Enterprise Architect, as examples.
One purpose of the BR UI is to configure the BR resources. It allows the user to create BR artifacts that are used for a working BR runtime and also monitors the behaviors and notifications of these BR resources as they run. In addition, the BR UI allows interaction with resources in the environment through, for instance, relationships and their surfaced properties and operations. The user can add resources to BR to affect recovery and behaviors of the runtime environment.
The BR UI also surfaces recommendations and best practices in the form of templates. These are reusable constructs that present a best practice to the user which can then be approved and realized by the user.
Interaction with the BR UI is based on the typical editor save lifecycle used within, for instance, the developmental tool known as Eclipse (available and described at www.Eclipse.org). The user typically opens or edits an existing resource, makes modifications, and those modifications are not persisted back to the resource until the user saves the editor.
Predefined window layouts in Eclipse are called perspectives. Eclipse views and editors are displayed in accordance with the perspective's layout, which can be customized by the user. The BR UI provides a layout as exemplified in the screen display depicted in FIG. 5A.
Screen display 500 depicted in FIG. 5A displays one example of a Business Resilience Perspective. Starting in the upper left corner and rotating clockwise, the user interface includes, for instance:

1. Business Resilience View 502
This is where the user launches topologies and definition templates for viewing and editing.

2. Topology/Definition Template Editor 504
This is where the editors are launched from the Business Resilience View display. The user can have any number of editors open at one time.

3. Properties View/Topology Resources View/Search View 506
The property and topology resource views are driven off the active editor. They display information on the currently selected resource and allow the user to modify settings within the editor.

4. Outline View 508
This view provides a small thumbnail of the topology or template being displayed in the editor. The user can pan around the editor quickly by moving the thumbnail.
The topology is reflected by a RS, as shown in the screen display of FIG. 5B. In FIG. 5B, a Recovery Segment 550 is depicted, along with a list of one or more topology resources 552 of the RS (not necessarily shown in the current view of the RS).
In one example, the BR UI is created on the Eclipse Rich Client Platform (RCP), meaning it has complete control over the Eclipse environment, window layouts, and overall behavior. This allows BR to tailor the Eclipse platform and remove Eclipse artifacts not directly relevant to the BR UI application, allowing the user to remain focused, while improving usability.
BR extends the basic user interface of Eclipse by creating software packages called “plugins’ that plug into the core Eclipse platform architecture to extend its capabilities. By implementing the UI as a set of standard Eclipse plug-ins, BR has the flexibility to plug into Eclipse, WebSphere Integration Developer, or Rational product installs, as examples. The UI includes two categories of plug-ins, those that are BR specific and those that are specific to processing resources in the IT environment. This separation allows the resource plug-ins to be potentially re-used by other products.
By building upon Eclipse, BR has the option to leverage other tooling being developed for Eclipse. This is most apparent in its usage of BPEL workflow tooling, but the following packages and capabilities are also being leveraged, in one embodiment, as well:
   The Eclipse platform provides two graphical toolkit packages, GEF and Draw2D, which are used by BR, in one example, to render topology displays and handle the rather advanced topology layouts and animations. These packages are built into the base Eclipse platform and provide the foundation for much of the tooling and topology user interfaces provided by this design.
   The Eclipse platform allows building of advanced editors and forms, which are being leveraged for BR policy and template editing. Much of the common support needed for editors, from the common save lifecycle to undo and redo support, is provided by Eclipse.
   The Eclipse platform provides a sophisticated Welcome and Help system, which helps introduce and helps users to get started configuring their environment. Likewise, Eclipse provides a pluggable capability to create task instructions, which can be followed step-by-step by the user to accomplish common or difficult tasks.

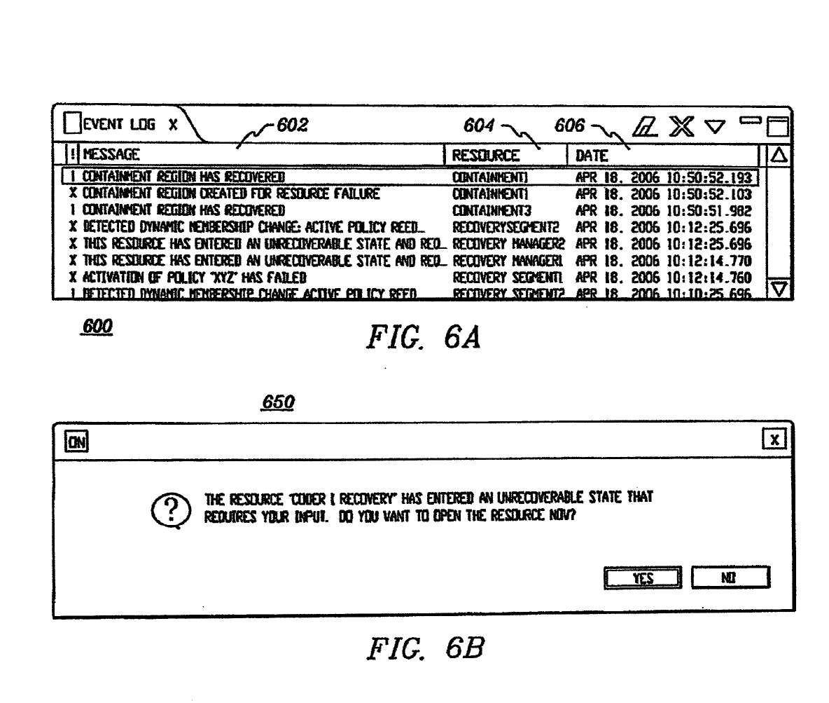

BR Admin Mailbox (406) (FIG. 4).
The BR Admin (or Administrative) Mailbox is a mechanism used by various flows of the BR runtime to get requests to an administrator to take some action. The Admin mailbox periodically retrieves information from a table, where BR keeps an up-to-date state.
As an example, the Admin Mailbox defines a mechanism where BR can notify the user of important events needing user attention or at least user awareness. The notifications are stored in the BR database so they can be recorded while the UI is not running and then shown to the user during their next session.
The notifications are presented to the user, in one example, in their own Eclipse view, which is sorted by date timestamp to bubble the most recent notifications to the top. An example of this view is shown in FIG. 6A. As shown, a view 600 is presented that includes messages 602 relating to resources 604. A date timestamp 606 is also included therewith.
Double clicking a notification opens an editor on the corresponding resource within the BR UI, which surfaces the available properties and operations the user may need to handle the notification.
The user is able to configure the UI to notify them whenever a notification exceeding a certain severity is encountered. The UI then alerts 650 the user of the notification and message when it comes in, as shown in FIG. 6B, in one example.
When alerted, the user can choose to open the corresponding resource directly. If the user selects No, the user can revisit the message or resource by using the above notification log view.

BR Install Logic (408) (FIG. 4).
The BR Install logic initializes the environment through accessing the set of preconfigured template information and vendor provided tables containing resource and relationship information, then applying any customizations initiated by the user.

Availability Configuration Templates (410):
Recovery Segment Templates
   The BR System has a set of Recovery Segment templates which represent common patterns of resources and relationships. These are patterns matched with each individual customer environment to produce recommendations for RS definitions to the customer, and offer these visually for customization or acceptance.
Redundancy Group Templates
   The BR System has a set of Redundancy Group templates which represent common patterns of forming groups of redundant resources. These are optionally selected and pattern matched with each individual customer environment to produce recommendations for RG definitions to a customer.
BR Manager Deployment Templates
   The BR System has a set of BR Manager Deployment templates which represent recommended configurations for deploying the BR Manager, its related Recovery Segments, and the related BR management components. There are choices for distribution or consolidation of these components. Best practice information is combined with optimal availability and performance characteristics to recommend a configuration, which can then be subsequently accepted or altered by the customer.
Pairing Templates
   The BR System has a set of Pairing Templates used to represent best practice information about which resources are related to each other.

The user interface, admin mailbox, install logic and/or template components can be part of the same computing unit executing BR Runtime or executed on one or more other distributed computing units.

To further understand the use of some of the above components and their interrelationships, the following example is offered. This example is only offered for clarification purposes and is not meant to be limiting in any way.

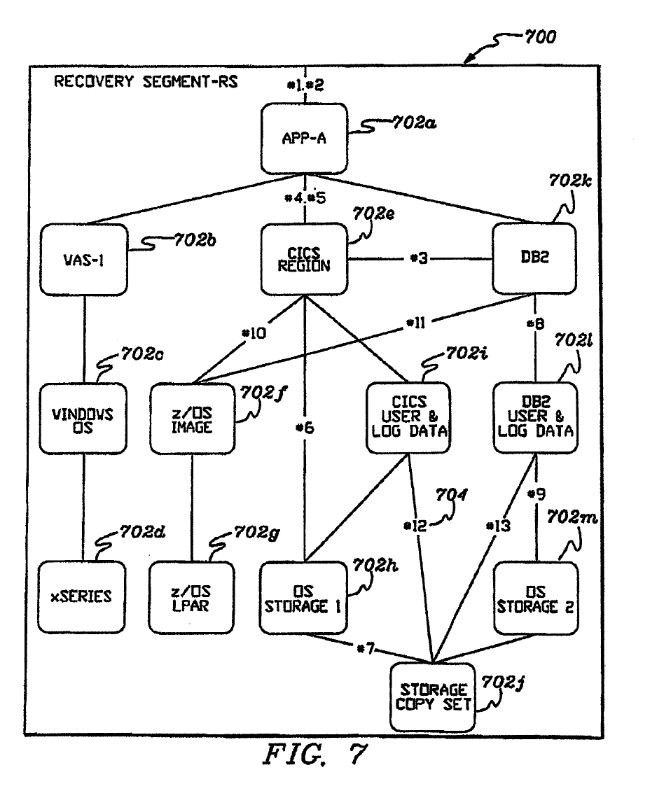

Referring to FIG. 7, a Recovery Segment RS 700 is depicted. It is assumed for this Recovery Segment that:
The Recovery Segment RS has been defined associated with an instantiated and deployed BR Manager for monitoring and management.
Relationships have been established between the Recovery Segment RS and the constituent resources 702a-702m.
A goal policy has been defined and validated for the Recovery Segment through interactions with the BR UI.
The following impact pairings have been assigned to the resources and relationships:

| Rule | Resource #1 | State | Resource #2 | State |
|---|---|---|---|---|
| 1 | App-A | Degraded | RS | Degraded |
| 2 | App-A | Unavailable | RS | Unavailable |
| 3 | DB2 | Degraded | CICS | Unavailable |
| 4 | CICS | Unavailable | App-A | Unavailable |
| 5 | CICS | Degraded | App-A | Degraded |
| 6 | OSStorage-1 | Unavailable | CICS | Degraded |
| 7 | OSStorage-1 | Unavailable | Storage Copy Set | Degraded |
| 8 | DB2 User & | Degraded | DB2 | Degraded |
| | Log Data | | | |
| 9 | OSStorage-2 | Unavailable | DB2 User & | Degraded |
| | | | Log Data | |
| 10 | z/OS | Unavailable | CICS | Unavailable |
| 11 | z/OS | Unavailable | DB2 | Unavailable |
| 12 | Storage Copy Set | Degraded | CICS User & | Degraded |
| | | | Log Data | |
| 13 | Storage Copy Set | Degraded | DB2 User & | Degraded |
| | | | Log Data | |

The rules in the above table correspond to the numbers in the figure. For instance, #12 (704) corresponds to Rule 12 above.
Observation mode for the resources in the Recovery Segment has been initiated either by the customer or as a result of policy validation.
The environment has been prepared as a result of that goal policy via policy validation and the possible creation and execution of a preparatory workflow.
The goal policy has been activated for monitoring by BR.

As a result of these conditions leading up to runtime, the following subscriptions have already taken place:
The BRM has subscribed to runtime state change events for the RS.
RS has subscribed to state change events for the constituent resources.

These steps highlight one example of an error detection process:
The OSStorage-1 resource 702h fails (goes Unavailable).
RS gets notified of state change event.
1^{st} level state aggregation determines:
   Storage Copy Set→Degraded
   CICS User & Log Data→Degraded
   DB2 User & Log Data→Degraded
   DB2→Degraded
   CICS→Unavailable
   App-A→Unavailable
1^{st} level state aggregation determines:
   RS→Unavailable
BRM gets notified of RS state change. Creates the following Containment Region:

| Resource | Reason |
|---|---|
| OSStorage-1 | Unavailable |
| Storage Copy Set | Degraded |
| CICS User & Log Data | Degraded |
| DB2 User & Log Data | Degraded |
| DB2 | Degraded |
| App-A | Unavailable |
| CICS | Unavailable |
| RS | Unavailable |

Creates a recovery workflow based on the following resources:

| Resource | State |
|---|---|
| OSStorage-1 | Unavailable |
| Storage Copy Set | Degraded |
| CICS User & Log Data | Degraded |
| DB2 User & Log Data | Degraded |
| DB2 | Degraded |
| App-A | Unavailable |
| CICS | Unavailable |
| RS | Unavailable |

In addition to the above, BR includes a set of design points that help in the understanding of the system. These design points include, for instance:

### Goal Policy Support

BR is targeted towards goal based policies—the customer configures his target availability goal, and BR determines the preparatory actions and recovery actions to achieve that goal (e.g., automatically).

Availability management of the IT infrastructure through goal based policy is introduced by this design. The BR system includes the ability to author and associate goal based availability policy with the resource Recovery Segments described herein. In addition, support is provided to decompose the goal policy into configuration settings, preparatory actions and runtime procedures in order to execute against the deployed availability goal. In one implementation of the BR system, the Recovery Time Objective (RTO—time to recover post outage) is a supported goal policy. Additional goal policies of data currency (e.g., Recovery Point Objective) and downtime maximums, as well as others, can also be implemented with the BR system. Recovery Segments provide the context for association of goal based availability policies, and are the scope for goal policy expression supported in the BR design. The BR system manages the RTO through an understanding of historical information, metrics, recovery time formulas (if available), and actions that affect the recovery time for IT resources.

RTO goals are specified by the customer at a Recovery Segment level and apportioned to the various component resources grouped within the RS. In one example, RTO goals are expressed as units of time intervals, such as seconds, minutes, and hours. Each RS can have one RTO goal per Pattern System Environment associated with the RS. Based on the metrics available from the IT resources, and based on observed history and/or data from the customer, the RTO goal associated with the RS is evaluated for achievability, taking into account which resources are able to be recovered in parallel.

Based on the RTO for the RS, a set of preparatory actions expressed as a workflow is generated. This preparatory workflow configures the environment or makes alterations in the current configuration, to achieve the RTO goal or to attempt to achieve the goal.

In terms of optimizing RTO, there are tradeoffs associated with the choices that are possible for preparatory and recovery actions. Optimization of recovery choice is performed by BR, and may include interaction at various levels of sophistication with IT resources. In some cases, BR may set specific configuration parameters that are surfaced by the IT resource to align with the stated RTO. In other cases, BR may request that an IT resource itself alter its management functions to achieve some portion of the overall RS RTO. In either case, BR aligns availability management of the IT resources contained in the RS with the stated RTO.

### Metrics and Goal Association

In this design, as one example, there is an approach to collecting the required or desired metrics data, both observed and key varying factors, system profile information that is slow or non-moving, as well as potential formulas that reflect a specific resource's use of the key factors in assessing and performing recovery and preparatory actions, historical data and system information. The information and raw metrics that BR uses to perform analysis and RTO projections are expressed as part of the IT resources, as resource properties. BR specific interpretations and results of statistical analysis of key factors correlated to recovery time are kept as BR Specific Management data (BRMD).

### Relationships Used by BR, and BR Specific Resource Pairing Information

BR maintains specific information about the BR management of each resource pairing or relationship between resources. Information regarding the BR specific data for a resource pairing is kept by BR, including information such as ordering of operations across resources, impact assessment information, operation effect on availability state, constraint analysis of actions to be performed, effects of preparatory actions on resources, and requirements for resources to co-locate or anti-co-locate.

### Evaluation of Failure Scope

One feature of the BR function is the ability to identify the scope and impact of a failure. The BR design uses a Containment Region to identify the resources affected by an incident. The Containment Region is initially formed with a fairly tight restriction on the scope of impact, but is expanded on receiving errors related to the first incident. The impact and scope of the failure is evaluated by traversing the resource relationships, evaluating information on BR specific resource pairing information, and determining most current state of the resources impacted.

### Generation and Use of Workflow

Various types of preparatory and recovery processes are formulated and in some cases, optionally initiated. Workflows used by BR are dynamically generated based on, for instance, customer requirements for RTO goal, based on actual scope of failure, and based on any configuration settings customers have set for the BR system.

A workflow includes one or more operations to be performed, such as Start CICS, etc. Each operation takes time to execute and this amount of time is learned based on execution of the workflows, based on historical data in the observation log or from customer specification of execution time for operations. The workflows formalize, in a machine readable, machine editable form, the operations to be performed.

In one example, the processes are generated into Business Process Execution Language (BPEL) compliant workflows with activities that are operations on IT resources or specified manual, human activities. For example, BRM automatically generates the workflows in BPEL. This automatic generation includes invoking routines to insert activities to build the workflow, or forming the activities and building the XML (Extensible Mark-Up Language). Since these workflows are BPEL standard compliant, they can be integrated with other BPEL defined workflows which may incorporate manual activities performed by the operations staff. These BR related workflows are categorized as follows, in one example:
Preparatory—Steps taken during the policy prepare phase in support of a given goal, such as the setting of specific configuration values, or the propagation of availability related policy on finer grained resources in the Recovery Segment composition. BR generates preparatory workflows, for instance, dynamically. Examples of preparatory actions include setting up storage replication, and starting additional instances of middleware subsystems to support redundancy.
Recovery—Steps taken as a result of fault detection during runtime monitoring of the environment, such as, for example, restarting a failed operating system (OS). BR generates recovery workflows dynamically, in one example, based on the actual failure rather than a prespecified sequence.
Preventive—Steps taken to contain or fence an error condition and prevent the situation from escalating to a more substantial outage or impact; for example, the severing of a failed resource's relationship instances to other resources. Preventive workflows are also dynamically generated, in one example.
Return—Steps taken to restore the environment back to ‘normal operations’ post recovery, also represented as dynamically generated workflows, as one example.

### Capturing of Workflow Information

Since the set of BR actions described above modify existing IT environments, visibility to the actions that are taken by BR prior to the actual execution is provided. To gain trust in the decisions and recommendations produced by BR, the BR System can run in ‘advisory mode’. As part of advisory mode, the possible actions that would be taken are constructed into a workflow, similar to what would be done to actually execute the processes. The workflows are then made visible through standard workflow authoring tooling for customers to inspect or modify. Examples of BPEL tooling include:
Bolie, et al., BPEL Cookbook: Best Practices for SOA-based Integration and Composite Applications Development, ISBN 1904811337, 2006, PACKT Publishing, hereby incorporated herein by reference in its entirety;
Juric, et al., Business Process Execution Language for Web Services: BPEL and BPEL YWS, ISBN 1-904811-18-3, 2004, PACKT Publishing, hereby incorporated herein by reference in its entirety.
http://www-306.ibm.com/software/integration/wid/about/?S_CMP=may
http://www.eclipse.org/bpel/
http://www.parasoft.com/jsp/products/home jsp;jessionid=aaa56iqFywA-HJ?product=BPEL&redname=googbpelm&referred=searchengine%2Fgoogle%Fbpel

### Tooling Lifecycle, Support of Managed Resources and Roles

BR tooling spans the availability management lifecycle from definition of business objectives, IT resource selection, availability policy authoring and deployment, development and deployment of runtime monitors, etc. In one example, support for the following is captured in the tooling environment for the BR system:
Visual presentation of the IT resources & their relationships, within both an operations and administration context.
Configuration and deployment of Recovery Segments and BRMs.
Authoring and deployment of a BR policy.
Modification of availability configuration or policy changes for BR.
BPEL tooling to support viewing of BR created, as well as customer authored, workflows.
BPEL tooling to support monitoring of workflow status, related to an operations console view of IT resource operational state.

### Policy Lifecycle

The policy lifecycle for BR goal policies, such as RTO goals, includes, for example:
Define—Policy is specified to a RS, but no action is taken by the BRM to support the policy (observation information may be obtained).
Validate—Policy is validated for syntax, capability, etc.; preparatory workflow created for viewing and validation by customer.
Prepare—Preparatory action workflows are optionally executed.
Activate—Policy is activated for runtime monitoring of the environment.
Modify—Policy is changed dynamically in runtime.

### Configurable State Aggregation

One of the points in determining operational state of a Recovery Segment is that this design allows for customers to configure a definition of specific ‘aggregated’ states, using properties of individual IT resources. A Recovery Segment is an availability management context, in one example, which may include a diverse set of IT resources.

The customer may provide the rules logic used within the Recovery Segment to consume the relevant IT resource properties and determine the overall state of the RS (available, degraded and unavailable, etc). The customer can develop and deploy these rules as part of the Recovery Segment availability policy. For example, if there is a database included in the Recovery Segment, along with the supporting operating system, storage, and network resources, a customer may configure one set of rules that requires that the database must have completed the recovery of in-flight work in order to consider the overall Recovery Segment available. As another example, customers may choose to configure a definition of availability based on transaction rate metrics for a database, so that if the rate falls below some value, the RS is considered unavailable or degraded, and evaluation of ‘failure’ impact will be triggered within the BR system. Using these configurations, customers can tailor both the definitions of availability, as well as the rapidity with which problems are detected, since any IT resource property can be used as input to the aggregation, not just the operational state of IT resources.

### Failure During Workflow Sequences of Preparatory, Recovery, Preventive

Failures occurring during sequences of operations executed within a BPEL compliant process workflow are intended to be handled through use of BPEL declared compensation actions, associated with the workflow activities that took a failure. The BR System creates associated “undo” workflows that are then submitted to compensate, and reset the environment to a stable state, based on where in the workflow the failure occurred.

### Customer Values

The following set of customer values, as examples, are derived from the BR system functions described above, listed here with supporting technologies from the BR system:
Align total IT runtime environment to business function availability objectives:
   RS definition from representation of IT Resources;
   Goal (RTO) and action policy specification, validation and activation; and
   Tooling by Eclipse, as an example, to integrate with IT process management.
Rapid, flexible, administrative level:
   Alteration of operation escalation rules;
   Customization of workflows for preparatory and recovery to customer goals;
   Customization of IT resource selection from RG based on quality of service (QoS);
   Alteration of definition of IT resource and business application state (available, degraded, or unavailable);
   Customization of aggregated state;
   Modification of topology for RS and RG definition;
   Selection of BR deployment configuration;
   Alteration of IT resource recovery metrics;
   Customization of generated Pattern System Environments; and
   Specification of statistical tolerances required for system environment formation or recovery metric usage.
Extensible framework for customer and vendor resources:
   IT resource definitions not specific to BR System; and
   Industry standard specification of workflows, using, for instance, BPEL standards.
Adaptive to configuration changes and optimization:
   IT resource lifecycle and relationships dynamically maintained;
   System event infrastructure utilized for linkage of IT resource and BR management;
   IT resource recovery metrics identified and collected;
   IT resource recovery metrics used in forming Pattern System Environments;
   Learned recovery process effectiveness applied to successive recovery events;
   System provided measurement of eventing infrastructure timing;
   Dynamic formation of time intervals for aggregation of related availability events to a root cause; and
   Distribution of achieved recovery time over constituent resources.
Incremental adoption and coexistence with other availability offerings:
   Potential conflict of multiple managers for a resource based on IT representation;
   Workflows for recovery and preparatory reflect operations with meta data linked to existing operations;
   Advisory mode execution for preparatory and recovery workflows; and
   Incremental inclusion of resources of multiple types.
Support for resource sharing:
   Overlapping and contained RS;
   Merger of CR across RS and escalation of failure scope; and
   Preparatory and recovery workflows built to stringency requirements over multiple RS.
Extensible formalization of best practices based on industry standards:
   Templates and patterns for RS and RG definition;
   Preparatory and recovery workflows (e.g., BPEL) for customization, adoption; and
   Industry standard workflow specifications enabling integration across customer and multiple vendors.
Integration of business resilience with normal runtime operations and IT process automation:
   Option to base on IT system wide, open industry standard representation of resources;
   BR infrastructure used for localized recovery within a system, cluster and across sites; and
   Utilization of common system infrastructure for events, resource discovery, workflow processing, visualization.

Management of the IT environment is adaptively performed, as described herein and in a U.S. patent application “Adaptive Business Resiliency Computer System for Information Technology Environments,” (POU920070364US1), Bobak et al., co-filed herewith, which is hereby incorporated herein by reference in its entirety.

Many different sequences of activities can be undertaken in creating a BR environment. The following represents one possible sequence; however, many other sequences are possible. This sequence is provided merely to facilitate an understanding of a BR system and one or more aspects of the present invention. This sequence is not meant to be limiting in any way. In the following description, reference is made to various U.S. patent applications, which are co-filed herewith.

On receiving the BR and related product offerings, an installation process is undertaken. Subsequent to installation of the products, a BR administrator may define the configuration for BR manager instances with the aid of BRM configuration templates.

Having defined the BRM configuration a next step could be to define Recovery Segments as described in “Recovery Segments for Computer Business Applications,” (POU920070108US1), Bobak et al., which is hereby incorporated herein by reference in its entirety.

Definition of a RS may use a representation of resources in a topology graph as described in “Use of Graphs in Managing Computing Environments,” (POU920070112US1), Bobak et al., which is hereby incorporated herein by reference in its entirety.

It is expected that customers will enable BR operation in “observation” mode for a period of time to gather information regarding key metrics and operation execution duration associated with resources in a RS.

At some point, sufficient observation data will have been gathered or a customer may have sufficient knowledge of the environment to be managed by BR. A series of activities may then be undertaken to prepare the RS for availability management by BR. As one example, the following steps may be performed iteratively.

A set of functionally equivalent resources may be defined as described herein, in accordance with one or more aspects of the present invention.

Specification of the availability state for individual resources, redundancy groups and Recovery Segments may be performed as described in “Use of Multi-Level State Assessment in Computer Business Environments,” (POU920070114US1), Bobak et al., which is hereby incorporated herein by reference in its entirety.

Representations for the IT environment in which BR is to operate may be created from historical information captured during observation mode, as described in “Computer Pattern System Environment Supporting Business Resiliency,” (POU920070107US1), Bobak et al., which is hereby incorporated herein by reference in its entirety. These definitions provide the context for understanding how long it takes to perform operations which change the configuration—especially during recovery periods.

Information on relationships between resources may be specified based on recommended best practices—expressed in templates—or based on customer knowledge of their IT environment as described in “Conditional Computer Runtime Control of an Information Technology Environment Based on Pairing Constructs,” (POU920070110US1), Bobak et al., which is hereby incorporated herein by reference in its entirety. Pairing processing provides the mechanism for reflecting required or desired order of execution for operations, the impact of state change for one resource on another, the effect execution of an operation is expected to have on a resource state, desire to have one subsystem located on the same system as another and the effect an operation has on preparing the environment for availability management.

With preliminary definitions in place, a next activity of the BR administrator might be to define the goals for availability of the business application represented by a Recovery Segment as described in “Programmatic Validation in an Information Technology Environment,” (POU920070111US1), Bobak et al., which is hereby incorporated herein by reference in its entirety.

Managing the IT environment to meet availability goals includes having the BR system prioritize internal operations. The mechanism utilized to achieve the prioritization is described in “Serialization in Computer Management,” (POU920070105US1), Bobak et al., which is hereby incorporated herein by reference in its entirety.

Multiple operations are performed to prepare an IT environment to meet a business application's availability goal or to perform recovery when a failure occurs. The BR system creates workflows to achieve the required or desired ordering of operations, as described in “Dynamic Generation of processes in Computing Environments,” (POU920070123US1), Bobak et al., which is hereby incorporated herein by reference in its entirety.

A next activity in achieving a BR environment might be execution of the ordered set of operations used to prepare the IT environment, as described in “Dynamic Selection of Actions in an Information Technology Environment,” (POU920070117US1), Bobak et al., which is hereby incorporated herein by reference in its entirety.

Management by BR to achieve availability goals may be initiated, which may initiate or continue monitoring of resources to detect changes in their operational state, as described in “Real-Time Information Technology Environments,” (POU920070120US1), Bobak et al., which is hereby incorporated herein by reference in its entirety. Monitoring of resources may have already been initiated as a result of “observation” mode processing.

Changes in resource or redundancy group state may result in impacting the availability of a business application represented by a Recovery Segment. Analysis of the environment following an error is performed. The analysis allows sufficient time for related errors to be reported, insures gathering of resource state completes in a timely manner and insures sufficient time is provided for building and executing the recovery operations—all within the recovery time goal, as described in “Management Based on Computer Dynamically Adjusted Discrete Phases of Event Correlation,” (POU920070119US1), Bobak et al., which is hereby incorporated herein by reference in its entirety.

A mechanism is provided for determining if events impacting the availability of the IT environment are related, and if so, aggregating the failures to optimally scope the outage, as described in “Management of Computer Events in a Computer Environment,” (POU920070118US1), Bobak et al., which is hereby incorporated herein by reference in its entirety.

Ideally, current resource state can be gathered after scoping of a failure. However, provisions are made to insure management to the availability goal is achievable in the presence of non-responsive components in the IT environment, as described in “Managing the Computer Collection of Information in an Information Technology Environment,” (POU920070121US1), Bobak et al., which is hereby incorporated herein by reference in its entirety.

With the outage scoped and current resource state evaluated, the BR environment can formulate an optimized recovery set of operations to meet the availability goal, as described in “Defining a Computer Recovery Process that Matches the Scope of Outage,” (POU920070124US1), Bobak et al., which is hereby incorporated herein by reference in its entirety.

Formulation of a recovery plan is to uphold customer specification regarding the impact recovery operations can have between different business applications, as described in “Managing Execution Within a Computing Environment,” (POU920070115US1), Bobak et al., which is hereby incorporated herein by reference in its entirety.

Varying levels of recovery capability exist with resources used to support a business application. Some resources possess the ability to perform detailed recovery actions while others do not. For resources capable of performing recovery operations, the BR system provides for delegation of recovery if the resource is not shared by two or more business applications, as described in “Conditional Actions Based on Runtime Conditions of a Computer System Environment,” (POU920070116US1), Bobak et al., which is hereby incorporated herein by reference in its entirety.

Having evaluated the outage and formulated a set of recovery operations, the BR system resumes monitoring for subsequent changes to the IT environment.

In support of mainline BR system operation, there are a number of activities including, for instance:
Coordination for administrative task that employ multiple steps, as described in “Adaptive Computer Sequencing of Actions,” (POU920070106US1), Bobak et al., which is hereby incorporated herein by reference in its entirety.
Use of provided templates representing best practices in defining the BR system, as described in “Defining and Using Templates in Configuring Information Technology Environments,” (POU920070109US1), Bobak et al., which is hereby incorporated herein by reference in its entirety.
Use of provided templates in formulation of workflows, as described in “Using Templates in a Computing Environment,” (POU920070126US1), Bobak et al., which is hereby incorporated herein by reference in its entirety.
Making changes to the availability goals while supporting ongoing BR operation, as described in “Non-Disruptively Changing a Computing Environment,” (POU920070122US1), Bobak et al., which is hereby incorporated herein by reference in its entirety.
Making changes to the scope of a business application or Recovery Segment, as described in “Non-Disruptively Changing Scope of Computer Business Applications Based on Detected Changes in Topology,” (POU920070125US1), Bobak et al., which is hereby incorporated herein by reference in its entirety.
Detecting and recovery for the BR system is performed non-disruptively, as described in “Managing Processing of a Computing Environment During Failures of the Environment,” (POU920070365US1), Bobak et al., which is hereby incorporated herein in its entirety.

In order to build a BR environment that meets recovery time objectives, IT configurations within a customer's location are to be characterized and knowledge about the duration of execution for recovery time operations within those configurations is to be gained. IT configurations and the durations for operation execution vary by time, constituent resources, quantity and quality of application invocations, as examples. Customer environments vary widely in configuration of IT resources in support of business applications. Understanding the customer environment and the duration of operations within those environments aids in insuring a Recovery Time Objective is achievable and in building workflows to alter the customer configuration of IT resources in advance of a failure and/or when a failure occurs.

A characterization of IT configurations within a customer location is built by having knowledge of the key recovery time characteristics for individual resources (i.e., the resources that are part of the IT configuration being managed; also referred to as managed resources). Utilizing the representation for a resource, a set of key recovery time objective (RTO) metrics are specified by the resource owner. During ongoing operations, the BR manager gathers values for these key RTO metrics and gathers timings for the operations that are used to alter the configuration. It is expected that customers will run the BR function in “observation” mode prior to having provided a BR policy for availability management or other management. While executing in “observation” mode, the BR manager periodically gathers RTO metrics and operation execution durations from resource representations. The key RTO metrics properties, associated values and operation execution times are recorded in an Observation log for later analysis through tooling. Key RTO metrics and operation execution timings continue to be gathered during active BR policy management in order to maintain currency and iteratively refine data used to characterize customer IT configurations and operation timings within those configurations.

Examples of RTO properties and value range information by resource type are provided in the below table. It will be apparent to those skilled in the art that additional, less, and/or different resource types, properties and/or value ranges may be provided.

| Resource Type | Property | Value Range |
|---|---|---|
| Operating System | Identifier | Text |
| | State | Ok, stopping, planned stop, |
| | | stopped, starting, error, lost |
| | | monitoring capability, unknown |
| | Memory Size | Units in MB |
| | Number of systems in sysplex, if | integer |
| | applicable | |
| | Last IPL time of day | Units in time of day/clock |
| | Type of last IPL | Cold, warm, emergency |
| | Total Real Storage Available | Units in MB |
| | GRS Star Mode | Yes or No |
| | Complete IPL time to reach | Units of elapsed time |
| | ‘available’ | |
| | Total CPU using to reach | Units of elapsed time |
| | available during IPL | |
| | Total CPU delay to reach | Units of elapsed time |
| | available during IPL | |
| | Total Memory using to reach | Units in MB |
| | available during IPL | |
| | Total Memory delay to reach | Units of elapsed time |
| | available during IPL | |
| | Total i/o requests | Integer value, number of requests |
| | Total i/o using to reach available | Units of elapsed time |
| | during IPL | |
| | Total i/o delay to reach available | Units of elapsed time |
| | during IPL | |
| Computer System (LPAR, | Identifier | Text |
| Server, etc.) | | |
| | State | Ok, stopping, stopped, planned |
| | | down, starting, error, lost |
| | | monitoring capability, unknown |
| | Type of CPU - model, type, | Text value |
| | serial | |
| | Number of CPUs | integer |
| | Number of shared processors | integer |
| | Number of dedicated processors | integer |
| | Last Activate Time of Day | Units in time of day/clock |
| Network Components | | |
| Group of Network Connections | Identity | |
| | Operational State | Ok, Starting, Disconnected, |
| | | Stopping, Degraded, Unknown |
| | State of each associated Network | Text |
| | Application Connection | |
| | Performance Stats on loss and | Complex |
| | delays | |
| | Recovery Time for any | Units in elapsed time |
| | associated application network | |
| | connections | |
| | Number of active application | Integer |
| | network connections associated | |
| | at time of network problem | |
| | Stopped Time/duration for | Units in elapsed time |
| | group of connectoins | |
| | Maximum Network Recovery | Units in elapsed time |
| | Time for any application | |
| | connection in group | |
| | Maximum Number of active | Integer |
| | connections at time of network | |
| | problem encountered, for any | |
| | application connection in group | |
| | Maximum Number of | Integer |
| | connections processed at time of | |
| | network recovery, for the group | |
| | of connections | |
| | Maximum network connection | Units in elapsed time |
| | recovery time/duration for any | |
| | application connection in the | |
| | group | |
| | Maximum Number of | Integer |
| | connections dropped at time of | |
| | application network connection | |
| | recovery, for any application | |
| | connection in the group | |
| Network Application Connection | Identity | Text |
| | State | Ok, Stopping, Degraded, Error, |
| | | Unknown |
| | Configuration Settings | Complex |
| | Associated TCP/IP Parameter | Text |
| | Settings | |
| | Requirement Policies | QoS or BR policies |
| | Performance Statistics, rules, | Complex |
| | service class, number of active | |
| | Network OS services | |
| | State update Interval | Units of elapsed time |
| | Last restart time of day | Units in time of day/clock |
| | Last Restart Time/Duration | Units in elapsed time |
| | Network Recovery Time for app | Units in elapsed time |
| | connection | |
| | Number of active connections at | Integer |
| | time of network problem | |
| | encountered, on a per app | |
| | connection basis | |
| | Number of connections | Integer |
| | processed at time of network | |
| | recovery, for the app connection | |
| | application network connection | Units in elapsed time |
| | recovery time/duration | |
| | Number of connections at time of | Integer |
| | application network connection | |
| | problem encountered | |
| | Number of connections | Integer |
| | processed at time of application | |
| | network connection recovery | |
| | Number of connections dropped | Integer |
| | at time of application network | |
| | connection recovery | |
| Network Host Connection | Identity | Text |
| | State | Ok, Stopping, Degraded, Error, |
| | | Unknown |
| | Configuration Settings | Complex |
| | Associated TCP/IP Parameter | Text |
| | Settings | |
| | Requirement Policies | QoS or BR policies |
| | Performance Statistics, rules, | Complex |
| | service class, number of active | |
| | Network OS services | |
| | State update Interval | Units of elapsed time |
| | Last restart time of day | Units in time of day/clock |
| | Last Restart Time/Duration | Units in elapsed time |
| | Number of QoS Events, | Integer |
| | indicating potential degradation | |
| | Number of QoS Events handled, | Integer |
| | Last handled QoS Event | Text |
| Database Subsystem | Name, identifier | Text |
| | Operational State | Operational, Nonoperational, |
| | | starting, stopping, in recovery, |
| | | log suspended, backup initiated, |
| | | restore initiated, restore |
| | | complete, in checkpoint, |
| | | checkpoint completed, applying |
| | | log, backing out inflights, |
| | | resolving indoubts, planned |
| | | termination, lost monitoring |
| | | capability |
| | Time spent in log apply | Units of elapsed time |
| | Time spent during inflight | Units of elapsed time |
| | processing | |
| | Time spent during indoubt | Units of elapsed time |
| | processing | |
| | Total time to restart | Units of elapsed time |
| | Checkpoint frequency | Units of time |
| | Backout Duration | Number of records to read back |
| | | in log during restart processing |
| | CPU Used during Restart | Units of elapsed time |
| | CPU Delay during Restart | Units of elapsed time |
| | Memory Used during Restart | Units in MB |
| | Memory Delay during Restart | Units of elapsed time |
| | I/O Requests during restart | Integer value of number of |
| | | requests |
| | I/O using during restart | Units of elapsed time |
| | I/O Delay during restart | Units of elapsed time |
| Database Datasharing Group | Identifer | Text |
| | Operational State | Operational, nonoperational, |
| | | degraded (some subset of |
| | | members non operational), lost |
| | | monitoring capability |
| | Number of locks in Shared | Integer value |
| | Facility | |
| | Time spent in lock cleanup for | Elapsed time value |
| | last restart | |
| Database | Identifier | Text |
| Tablespace | Identifier | Text |
| Transaction Region | Identifier | Text |
| | Name | Text |
| | Associated job name | Text |
| | Maximum number of tasks/ | Integer value |
| | threads | |
| | Restart type for next restart | Warm, cold, emergency |
| | Forward log name | Text |
| | System log name | Text |
| | Operational State | Operational, nonoperational, in |
| | | recovery, starting, stop normal |
| | | first quiesce, stop normal second |
| | | quiesce, stop normal third |
| | | quiesce |
| | Time spent in log apply | Units of elapsed time |
| | Time during each recovery stage | Units of elapsed time |
| | Total time to restart | Units of elapsed time |
| | CPU Used during Restart | Units of elapsed time |
| | CPU Delay during Restart | Units of elapsed time |
| | Memory Used during Restart | Units in MB |
| | Memory Delay during Restart | Units of elapsed time |
| | I/O Requests during restart | Integer value of number of |
| | | requests |
| | I/O connect time during restart | Units of elapsed time |
| | I/O Delay during restart | Units of elapsed time |
| | System Logsize | Units in MB |
| | Forward Logsize | Units in MB |
| | Activity Keypoint frequency | Integer - number of writes before |
| | | activity checkpoint taken |
| | Average Transaction Rate for | Number of transactions per |
| | this region | second, on average |
| Transaction Group | Group name | Text |
| Transaction Region File | Filename | Text |
| | Region Name | Text |
| | Dataset Name | Text |
| | Operational State | Operational/enabled, |
| | | nonoperational/disabled |
| | Open status | Open, closed, closing |
| Transaction | Identifier | Text |
| | Operational State | Running, failed, shunted, retry in |
| | | progress |
| | Region Name (s) that can run this | Text |
| | transaction | |
| | Program Name | Text |
| Logical Replication Group of | Identity | Text |
| related datasets | | |
| | State | |
| | Required currency characteristics | Complex |
| | for datasets | |
| | Required consistency | Complex |
| | characteristics for datasets | |
| Replication Group | Identity | |
| | State | |
| Replication Session | Identity | |
| | State | Established, in progress |
| | | replication, replication successful |
| | | complete |
| | Type of Session | Flash copy, metro mirror, etc. |
| | Duration of last replication | Units in elapsed time |
| | Time of Day for last replication | Units in time of day/clock |
| | Amount of data replicated at last | Units in MB |
| | replication | |
| Roleset | Identity | Text |
| | State | |
| CopySet | Identity | Text |
| | State | |
| Dataset | Identity | Text |
| | State | Open, Closed |
| Storage Group | Identity | Text |
| | State | |
| Storage Volume | Identity | Text |
| | State | Online, offline, boxed, unknown |
| Logical Storage Subsystem | Identity | Text |
| | State | |
| Storage Subsystem | Identity | Text |
| | State | |
| | Subsystem I/O Velocity - ratio of | |
| | time channels are being used | |
| Replication Link (Logical) | Identity | Text |
| between Logical Subsystems | | |
| | State | Operational, nonoperational, |
| | | degraded redundancy |
| | Number of configured pipes | Integer |
| | Number of operational pipes | Integer |

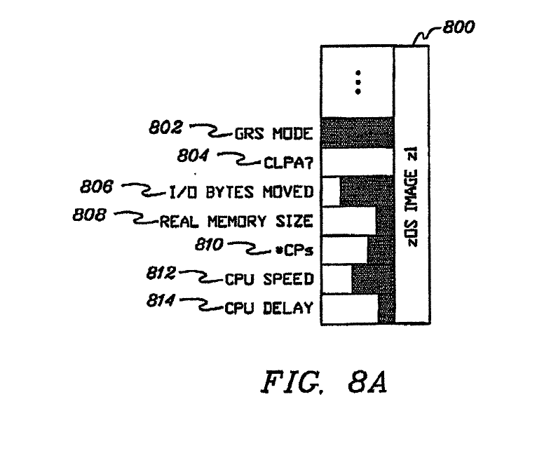

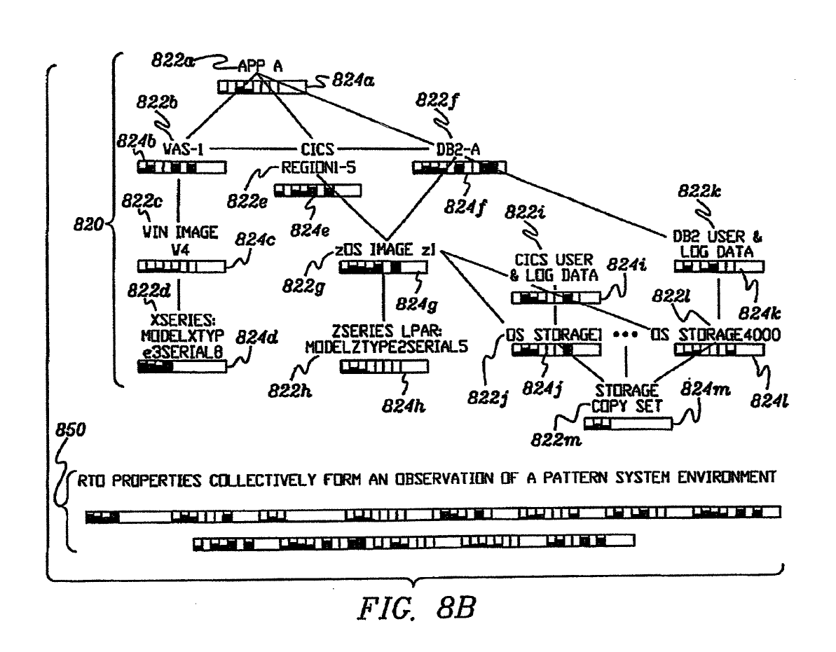

A specific example of key RTO properties for a z/OS® image is depicted in FIG. 8A. As shown, for a z/OS® image 800, the following properties are identified: GRS mode 802, CLPA? (i.e., Was the link pack area page space initialized?) 804, I/O bytes moved 806, real memory size 808, # CPs 810, CPU speed 812, and CPU delay 814, as examples.

The z/OS® image has a set of RTO metrics associated therewith, as described above. Other resources may also have its own set of metrics. An example of this is depicted in FIG. 8B, in which a Recovery Segment 820 is shown that includes a plurality of resources 822a-m, each having its own set of metrics 824a-m, as indicated by the shading.

Further, in one example, the RTO properties from each of the resources that are part of the Recovery Segment for App A have been gathered by BR and formed into an “observation” for recording to the Observation log, as depicted at 850.

Resources have varying degrees of functionality to support RTO goal policy. Such capacity is evaluated by BR, and expressed in resource property RTOGoalCapability in the BRMD entry for the resource. Two options for BR to receive information operation execution timings are: use of historical data or use of explicitly customer configured data. If BR relies on historical data to make recovery time projections, then before a statistically meaningful set of data is collected, this resource is not capable of supporting goal policy. A mix of resources can appear in a given RS—some have a set of observations that allow classification of the operation execution times, and others are explicitly configured by the customer.

Calculation of projected recovery time can be accomplished in two ways, depending on customer choice: use of historical observations or use of customers input timings. The following is an example of values for the RTOGoalCapability metadata that is found in the BRMD entry for the resource that indicates this choice:

| | |
|---|---|
| UseHistoricalObservations | The resource has a collection of |
| | statistically meaningful observations |
| | of recovery time, where definition of |
| | ‘statistically valid’ is provided on a resource |
| | basis, as default by BR, but tailorable |
| | by customers |
| UseCustomerInputTimings | The customer can explicitly set |
| | the operation timings for a resource |

If the customer is in observation mode, then historical information is captured, regardless of whether the customer has indicated use of explicitly input timings or use of historical information.

The administrator can alter, on a resource basis, which set of timings BR is to use. The default is to use historical observations. In particular, a change source of resource timing logic is provided that alters the source that BR uses to retrieve resource timings. The two options for retrieving timings are from observed histories or explicitly from admin defined times for operation execution. The default uses information from the observed histories, gathered from periodic polls. If the customer defines times explicitly, the customer can direct BR to use those times for a given resource. If activated, observation mode continues and captures information, as well as running averages, and standard deviations. The impact to this logic is to alter the source of information for policy validation and formulation of recovery plan.

With respect to the historical observations, there may be a statistically meaningful set of observations to verify. The sample size should be large enough so that a time range for each operation execution can be calculated, with a sufficient confidence interval. The acceptable number of observations to qualify as statistically meaningful, and the desired confidence interval are customer configurable using BR UI, but provided as defaults in the BRMD entry for the resource. The default confidence interval is 95%, in one example.

There are metrics from a resource that are employed by BR to enable and perform goal management. These include, for instance:

| Metric | Qualification |
|---|---|
| Last observed recovery/restart time | In milliseconds; |
| | or alternately specifying units to use in calculations |
| The key factors and associated | Captured at last observed recovery time, and capturable |
| values of the resource that affect | at a point in time by BR |
| recovery time | |
| The key factors and associated | Captured at last observed recovery time, and capturable |
| values of the resource that affect | at a point in time by BR |
| other dependent resources' recovery | |
| times | |
| Observed time interval from ‘start’ | If there are various points in the resource recovery |
| state to each ‘non-blocking’ state | lifecycle at which it becomes non-blocking to other |
| | resources which depend upon it, then: |
| | Observed time interval from ‘start’ state to each |
| | ‘non-blocking’ state |
| Resource Consumption Information | If the resource can provide information about its |
| | consumption, or the consumption of dependent |
| | resources, on an interval basis, then BR will use this |
| | information in forming PSEs and classifying timings. |
| | One example of this is: cpu, i/o, memory usage |
| | information that is available from zOS WLM for an |
| | aggregation of processes/address spaces over a given |
| | interval. |

There is also a set of information about the resource that is employed—this information is provided as defaults in the BRMD entry for the resource, but provided to the BR team in the form of best practices information/defaults by the domain owners:
The operational state of the resource at which the observed recovery time interval started.
The operational state of the resource at which the observed recovery time interval ended.
The operational states of the resource at which point it can unblock dependent resources (example: operational states at which a DB2 could unblock new work from CICS, at which it could allow processing of logs for transactions ongoing at time of failure . . . ).
Values of statistical thresholds to indicate sufficient observations for goal managing the resource (number of observations, max standard deviations, confidence level).

In addition to the resources defined herein as part of the IT configuration that is managed, there are other resources, referred to herein as assessed resources. Assessed resources are present primarily to provide observation data for PSE formation, and to understand impact(s) on managed resources. They do not have a decomposed RTO associated with them nor are they acted on for availability by BR. Assessed resources have the following characteristics, as examples:
Are present to collect observation data for PSE formation.
Are present to understand impacts on managed resources.
No decomposed RTO is associated with an assessed resource.
They are resources on which resources managed by BR depend upon, but are not directly acted on for availability by BR.
They are resources removed (or not explicitly added) from the actively monitored set of resources by the BR admin during RS definition.
They are resources that BR does not try to recover and BR thus will not invoke any preparatory or recovery operations on them.

Similarly, there are likely scenarios where a resource exists in a customer environment that already has an alternative availability management solution, and does not require BR for its availability. However, since other resources that are managed by BR may be dependent on them, they are observed and assessed in order to collect observation data and understand their impacts on managed resources. Additionally, there may be resources that do not have alternative management solutions, but the customer simply does not want them managed by BR, but other managed resources are dependent upon them. They too are classified as assessed resources.

These assessed resources share many of the same characteristics of managed resources, such as, for example:
They have an entry in the BRMD, depending on their use, and the BRMD entry has an indication of assessed vs. managed.
The RS subscribes to state change notifications for assessed resources (and possibly other notifiable properties).
Relationships between observed and managed resources are possible (and likely).
BR monitors for lifecycle events on assessed resources in the same manner as for managed resources.
Assessed resources can be added and/or removed from Recovery Segments.
They can be used to contribute to the aggregated state of an RS.

Finally, there are a few restrictions that BR imposes upon assessed resources, in this embodiment:
Again, BR does not invoke any workflow operations on assessed resources.
A resource that is shared between two Recovery Segments is not categorized as an assessed resource in one RS and a managed resource in the other. It is one or the other in the RS's, but not both.

To facilitate the building of the customer's IT configuration, observations regarding the customer's environment are gathered and stored in an observation log. In particular, the observation log is used to store observations gathered during runtime in customer environments, where each observation is a collection of various data points. They are created for each of the Recovery Segments that are in “observation” mode. These observations are used for numerous runtime and administrative purposes in the BR environment. As examples the observations are used:
To perform statistical analysis from the BR UI to form characterizations of customers' normal execution environments, represented in BR as Pattern System Environments (PSE).
To classify operations on resources into these PSEs for purposes of determining operation execution duration.
Help determine approximate path length of operations that are pushed down from BR to the resources, and possibly to the underlying instrumentation of each resource.
Help determine approximate path length of activities executed within BPEL workflows.
Finally, the data collected via the observation is also used to update the metadata associated with the resource (i.e., in the BRMD table) where appropriate.

BR gathers observations during runtime when “observation mode” is enabled at the Recovery Segment level. There are two means for enabling observation mode, as examples:
1. The BR UI allows the administrator to enable observation mode at a Recovery Segment, which will change its “ObservationMode” resource property to “True”, and to set the polling interval (default=15 minutes). The Recovery Segment is defined in order to allow observation mode, but a policy does not have to be defined or activated for it.
2. Once a policy is defined though and subsequently activated, observation mode is set for the Recovery Segment (due to the data being used in managing and monitoring the customer's environment). Thus, it is set automatically at policy activation, if not already set explicitly by the administrator (see 1 above) using the default polling interval (15 minutes).

The administrator may also disable observation mode for a Recovery Segment, which stops it from polling for data and creating subsequent observation records for insertion in the log. However, the accumulated observation log is not deleted. In one example, an RS remains in observation mode throughout its lifecycle. The UI displays the implications of disabling observation mode.

In BR, the observations that are collected by BR during runtime can be grouped into two categories, as examples:
1. Periodic poll.
2. Workflow (includes workflow begin/end, and workflow activity begin/end).

A periodic poll observation is a point-in-time snapshot of the constituent resources in a Recovery Segment. Observation data points are collected for those resources in the Recovery Segment(s) which have associated BR management data for any of the following reasons, as examples:
1. Resource has RTO properties.
2. Resource has operations.
3. Resource participates in the aggregated state for the Recovery Segment, in which it is contained.
4. Resource participates in any of the six types of pairing rules.

The full value of these observations is derived for an RS when they include data that has been gathered for its constituent resources, plus the resources that those are dependent upon. In one embodiment, the administrator is not forced to include all dependent resources when defining a Recovery Segment, and even if that were the case, there is nothing that prevents them from deleting various dependent resources. When defining a Recovery Segment, the BR UI provides an option that allows the customer to display the dependency graph for those resources already in the Recovery Segment. This displays the topology from the seed node(s) in the Recovery Segment down to and including the dependent leaf nodes. The purpose of this capability is to give the customer the opportunity to display the dependent nodes and recommend that they be included in the Recovery Segment.

Preparatory and recovery workflows are built by the BR manager to achieve the customer requested RTO policy based on resource operations timings. During active policy monitoring by the BR manager, measurements of achieved time for operations are recorded in observations to the log and used to maintain the running statistical data on operation execution times. Observations written to the log may vary in the contained resource RTO metrics and operation execution timings.

Observations are also collected from any of the BPEL workflows created by BR in the customer's environment. There is a standard template that each BR BPEL workflow uses. As part of that template, observation data is captured at the start of, during, and at the completion of each workflow. Specifically, in one example, one observation is created at the end of the workflow with data accumulated from completion of each activity. This information is used to gather timings for workflow execution for use in creating subsequent workflows at time of failure.

In accordance with an aspect of the present invention, management of a customer's environment is facilitated by defining and employing Redundancy Groups. For instance, Redundancy Groups are used to optimize the reconfiguration of resources to meet a desired goal, such as an availability goal or other goal. Redundancy groups are actively used during runtime to influence what operations are chosen (e.g., during reconfiguration) and what targets are selected for those operations. Further details associated with Redundancy Groups are provided below.

A Redundancy Group (RG) is a set of functionally equivalent resources. These resources can be represented in multiple ways, including, for instance, through the use of standards, such as the Common Information Model (CIM) Standard from the Distributed Management Task Force (DMTF) (see, e.g., http://www.dmtf.org/home). The RG configures and captures the resource existence, and relationship to other resource members. The state of the resource is used to evaluate selection of a target resource from a RG, but membership is not removed automatically when a resource becomes unavailable. Resources can be added to or removed from a RG by the customer or dynamically, as examples. Automated update of resources can be established through definition of criteria for inclusion/exclusion.

Redundancy Groups are defined to be, for instance:
Collections of operating system images for targeting middleware subsystem starts;
Collection of computer systems/servers for targeting operating system starts; or
Collection of redundant copies of middleware.

Redundancy Groups are created by the customer in one of two ways. The formation process can use a RG Definition Template or the customer can explicitly specify resource instances that can be used for functional equivalence. Once defined, these sets are programmatically managed for change, state of each member, and selection criteria for choosing target members. Definition of a RG does not include a minimum or maximum number of members. However, the members that are included are functionally equivalent resources.

The BR UI enforces three restrictions, as examples, on Redundancy Groups when they are created:
1. All resources are to be of the same type;
2. A Redundancy Group is to include at least one member; an empty RG cannot exist;
3. Names across Redundancy Groups are to be unique.

The Redundancy Group is implemented, in one example, as a DB2 table in the Business Resilience datastore that physically resides in the BR environment. That database is created at installation time. It is not associated with a particular resource and is not used to persist any resource properties. The typical access mechanism is via, for instance, JDBC calls from the BR UI client(s) and the BRM using JDBC type 4 drivers. One example of the physical model of a Redundancy Group is shown below.

[symbol]

REDUNDANCY_GROUP

[symbol]

RG_ID INTEGER [symbol]
DISPLAY_NAME: VARCHAR(96) [symbol]
ACTIVE_PREFERENCE: CHAR(1) [symbol]
AGGREGATED_STATE: INTEGER [symbol]
RESOURCE_STATE_RULE: VARCHAR(128) [symbol]
TS_UPDATE: TIMESTAMP

The Redundancy_Group table is used to associate various other DB2 entries via foreign keys. For example, to find the resources within a given Redundancy Group, the RG_ID can be used to query the BRMD table. The Redundancy Group table includes the following fields, as examples:

| Data Field | Data Type | Description | Keys |
|---|---|---|---|
| RG_ID | Integer | Generated integer key for | Primary |
| | | uniqueness via a DB2 sequence. | |
| | | Note all primary keys in the BR | |
| | | database will be a generated | |
| | | integer for compatibility with other | |
| | | non-DB2 databases. | |
| DISPLAY_NAME | Varchar(96) | Name as entered from the BR UI. | User |
| | | Display_Name uniqueness for RGs | |
| | | will be enforced by the UI. | |
| ACTIVE_PREFERENCE | Char(1) | An indication on whether only one | |
| | | member can be activated at any | |
| | | given time, or multiple members | |
| | | can be activated at the same time. | |
| | | By default, multiple members can | |
| | | be activated at any given time. | |
| AGGREGATED_STATE | Integer | Aggregated state of the RG | |
| RESOURCE_STATE_RULE | Varchar(128) | Aggregated state rule | |
| TS_UPDATE | Timestamp | Timestamp of initial create or last | |
| | | update and defaults to current | |
| | | timestamp | |

### Redundancy Group Formation

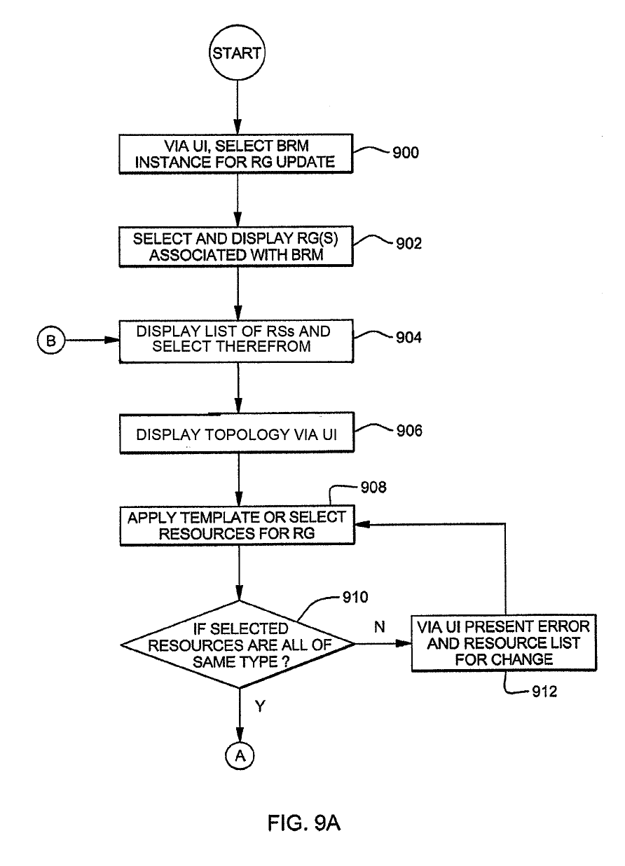

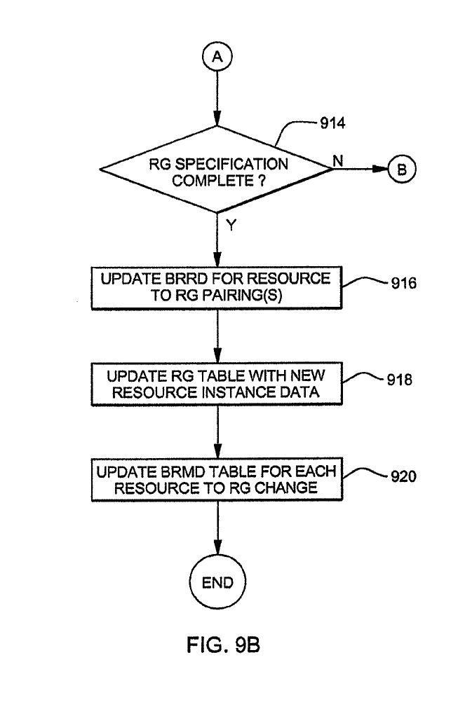

One embodiment of the logic associated with creating (or updating) a RG is described with reference to FIGS. 9A-9B. In this example, this logic is invoked by the UI component of the BR system, and performed by the BRM.

Referring to FIG. 9A, initially, via the UI, the user selects a BRM instance to be associated with the RG to be created (or updated), STEP 900. If there is no suitable BRM presented via the UI, then one is created. In one example, a BRM can be created through a start that can be performed through specific interfaces that are defined for program starts, depending on the environment. For example, the start can be via a JMX request. In starting the BRM, the server, operating system and hosting containers for the new BRM can be explicitly specified, or it can be based on the automated recommendations from best practice deployment templates. After the BRM is selected, the BR UI presents a list of RG(s) associated with the chosen BRM instance, STEP 902. From this list, the customer selects a RG to be updated or indicates that a new RG is being created.

The list of RSs associated with the selected BRM instance is displayed from which a selection is made via the UI, STEP 904. Further, the topology associated with the selected RS is displayed via the UI, STEP 906.

Likely candidate resources to be associated with the RG can be selected directly by the customer or selected based on templates applied to the topology, STEP 908. Resources which are selected for inclusion in the RG are validated by ensuring they are of the same type as other resources in the RG, INQUIRY 910. If a selected resource is not of the same type, an error is presented via the UI, as well as a resource list for change, STEP 912. Thereafter, processing continues at STEP 908.

Returning to INQUIRY 910, if the selected resources are of the same type, then a further determination is made as to whether the RG specification is complete, INQUIRY 914 (FIG. 9B). This determination is made via UI interaction with the customer. If RG specification is incomplete, processing continues at STEP 904.

Otherwise, when all additions to the RG have been selected, a set of relational table updates are performed. For instance, the BRRD table is updated to reflect relationships between the resource and the RG, STEP 916, and the RG table is updated with added resources, STEP 918. Further, the BRMD for each resource is updated to indicate its association with the RG, STEP 920. This concludes the define RG processing.

### Example of Redundancy Groups

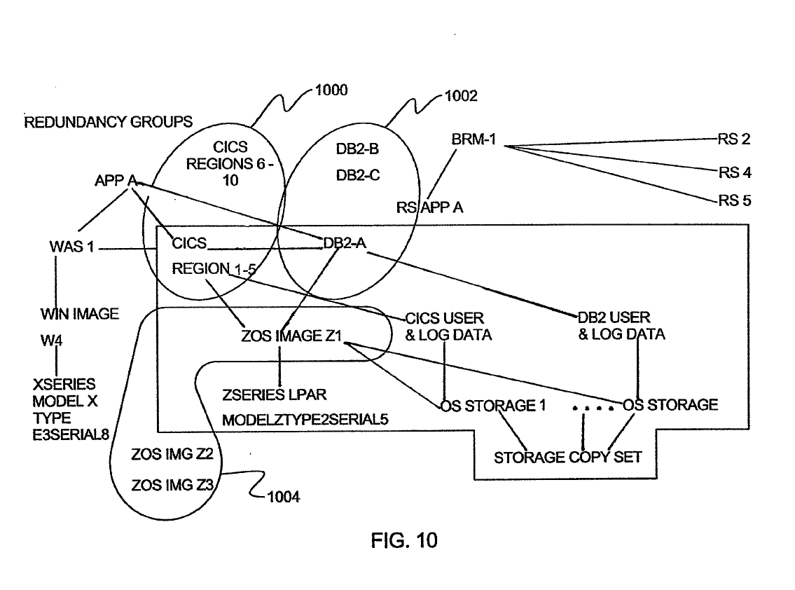

Examples of Redundancy Groups are depicted in FIG. 10. Three Redundancy Groups have been identified:
1. CICS Regions 1 thru 10 (1000);
2. DB2 instances A, B and C (1002);
3. zOS images z1, z2, and z3 (1004).

### Explicit Change to Redundancy Group

Changes to a Redundancy Group can be accomplished by explicitly adding or deleting resources from the RG. Interfaces may be used to add, delete, and alter the membership of resources within a RG. Resources can be members in multiple RGs, and change to one RG membership does not affect another RG membership. The explicit changes are processed to reflect the new configuration programmatically, and uses of the changed RG will pick up the new information, as long as there is not a recovery in process at the time the change is attempted.

Updates to RG membership follow the same flow as initial creation of an RG, as described with reference to FIGS. 9A-9B.

### Dynamic Change to Redundancy Group Membership

The RG membership can also be extended to change dynamically, based on monitoring for events in the environment that match specified filters. For example, if a server that matches a specific RG Template comes online, it can be considered and evaluated for automatic membership in one or more RGs. In an environment, there can be a mix of RGs that have automatic update of membership, and some that are required to be explicitly modified. The control over dynamically changeable RG and explicitly controlled RG is customizable.

The automatic membership is used, for instance, where there are a large number of members in a RG and where resources may be expected to be created and destroyed frequently. One example may be a pool of thousands of Windows® based webservers. (Windows® is a registered trademark of Microsoft Corporation, Redmond, Wash.)

When automatic membership is desired, there is a set of event conditions that is monitored in the environment to cause evaluation of a resource as a candidate member based on specified filters. Likewise, when these events report resource state change, there is an evaluation of the condition to determine whether any RG is to have members expelled due to the dynamic change capability.

### Participation of Redundancy Group in Pairings

Redundancy Groups can participate directly in pairings related to impact assessment or co-location requirements. For impact assessment pairings, RG can directly contribute to a RS-to-RG impact pairing rule. For co-location pairings, RG can directly participate in attract/repel type of co-locations with other resource specifications.

In addition to the pairings related to impact assessment and co-location, RG state can contribute to the set of conditions under which any of the pairing rules trigger. Since pairings are specified to be conditionally evaluated when certain environmental triggers exist, the RG state can be one of those environmental triggers.

### Impact Pairing Use

Across the runtime environment, there are a number of cases where there is information related to pairings of resources and operations on resources that BR will use. The assessment of the information across these pairings is dynamic to the current environment, rather than statically defined to be true across each instance of a given pairing of resources. Determination of pairing information use is performed by BR based on changes to resource state and a set of trigger rules defined with the pairing. Further details relating to pairing are described in “Conditional Computer Runtime Control of an Information Technology Environment Based on Pairing Constructs,” (POU920070110US1), which is hereby incorporated herein by reference in its entirety.

There are different categories of state changes which can impact other resources in some way, and each is considered in composing an impact pairing. These include, for instance:
a) Failure of a strict functional dependency. Example:
   ComputerSystem Hosts Operating System, where ComputerSystem fails.
b) Degradation of a functional dependency. Example:
   OperatingSystem Hosts DB2, where OperatingSystem degrades, condition: state of RG-OS degraded.
c) Failure of a non-functionally dependent resource. Example:
   CICS Uses DB2, where DB2 fails, condition: state of RG-DB2 failed.
d) Degradation of a non-functionally dependent resource. Example:
   CICS Uses DB2, wherein DB2 degrades, condition: state of RG-DB2 degraded.

### Redundancy Group State, Based on Member State

Redundancy Groups have a defined state that is directly correlated to the state of the constituent members of the RG. Each of the resources has an operational state, but the overall state of the grouping of the resources can be aggregated into a state for the RG, as further described below, as well as in “Use of Multi-Level State Assessment in Computer Business Environments,” (POU920070114US1), which is hereby incorporated herein by reference in its entirety.

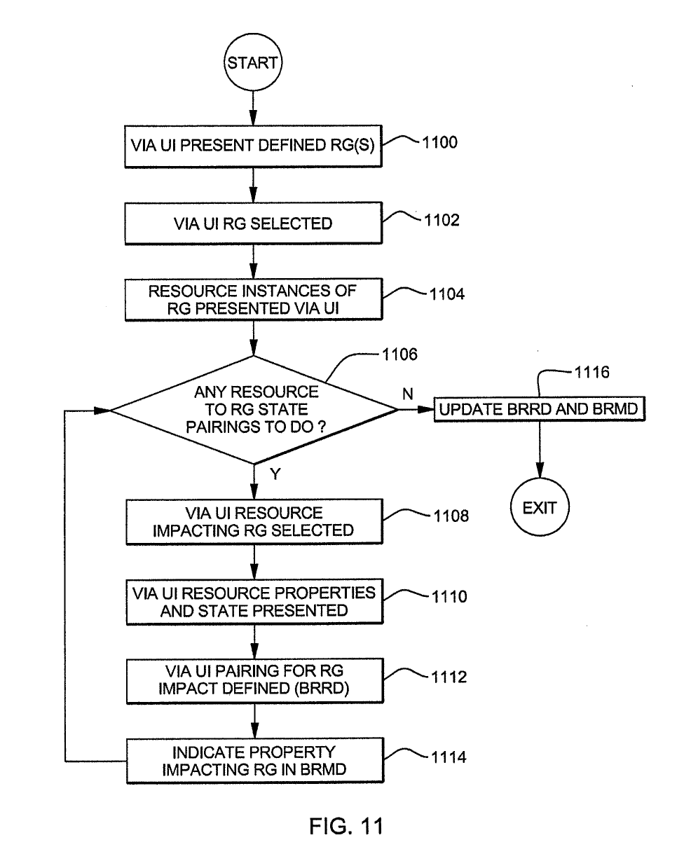

One embodiment of the logic to define RG aggregated state is described with reference to FIG. 11. In one example, this logic is invoked by the UI component of the BR System and controlled by the BRM with which the RG is associated.

Referring to FIG. 11, a list of defined RG(s) is presented through the UI, STEP 1100, to enable selection of the RG for which aggregated state is to be defined, STEP 1102. After selection of a RG to modify, the list of resource instances associated with the RG is presented, STEP 1104.

Thereafter, a determination is made as to whether there are any resource to RG state pairings to handle, INQUIRY 1106. If there are resource to RG impact effects to be defined, the resource effecting the state of the RG is selected, STEP 1108. Properties and state of the resource are presented for selection by the BR administrator, STEP 1110.

Specification of which property and associated value or resource state and the effect on the RG state are defined by the BR administrator, resulting in a temporary pairing rule—BRRD table entry—definition, STEP 1112. Moreover, the property impacting the RG is indicated in the BRMD, STEP 1114, and processing continues at STEP 1106.

When RG state based on member state specifications are complete, INQUIRY 1106, temporary pairing rules are made permanent in the BRRD table and BRMD table, STEP 1116. This concludes processing.

Determining Overall Availability of RS from State of RG

The business application represented by the Recovery Segment can have a number of inputs that affect its availability or degradation. The collective state of the RG can contribute as a factor to determining overall RS/business application state. That is, the state for the RG can be used in determining overall state of the RS and can be used as input to determine target selection among RG or within a RG. In addition, the management of a RG as an entity that has dynamic characteristics, defined state, and expected change, allows for the selection techniques from a RG to adapt to the current operating environment, rather than using a fixed preference list for selection, as described herein.

Using RG as part of the impact assessment definitions allows for redundancy characteristics of an environment to contribute to the assessment of whether a business application that may be represented by a Recovery Segment is ‘available’ vs. ‘degraded’. In some cases, customer environments are functioning as expected, however the redundancy capability is at risk or lost. The loss of redundancy is not always programmatically detected, identified, captured, or recommended for action. Since the loss of redundancy can affect business application availability (whether or not the redundancy reduction/loss is detected), programmatic specification and dynamic evaluation of pairing information allows more time sensitive recoveries and reduces overall risk to the business application. The feature to allow RG participation in pairing definitions for Business Resiliency allows customers to define whether a RG contributes to the state of a business application, and if so, to what extent.

In Define RS Aggregated State, the BR administrator is presented the set of RG(s) associated with the resources forming the RS as potential candidates on which the state of the RS could be altered.
i. For any resource in the environment, index to find associated RG, and offer those as potentials to participate in state aggregation.

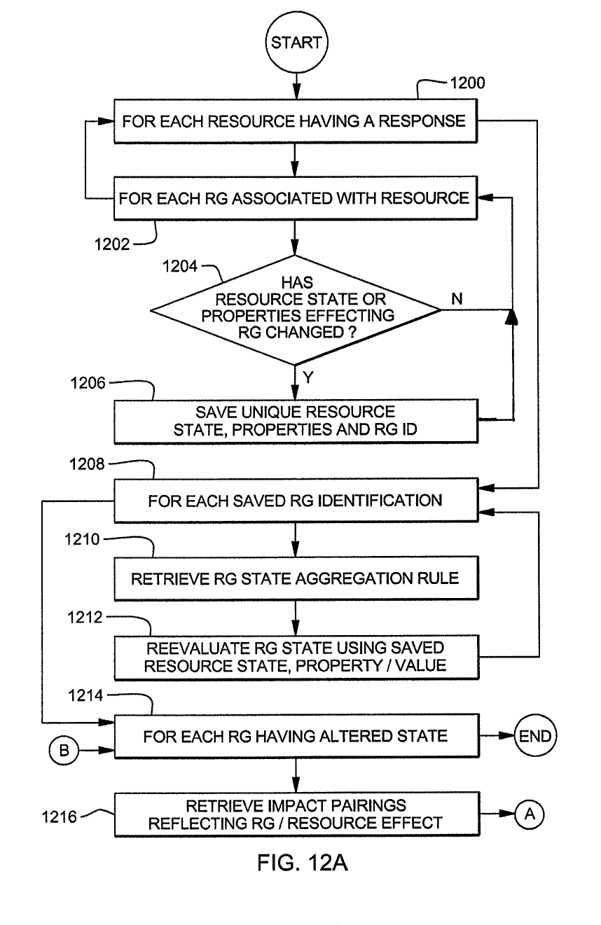

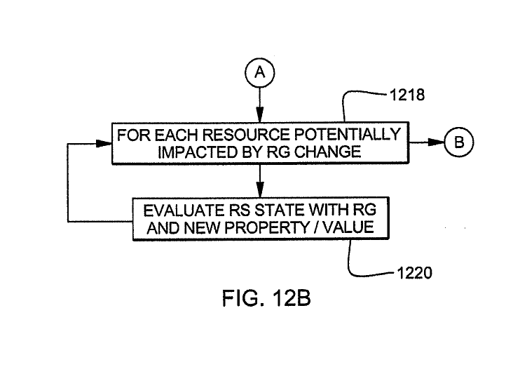

In performing monitoring of the environment, a periodic poll of resource state and property values is performed. The following processing may be introduced in support of RG state having an impact on RS state. In particular, one embodiment of the logic used to manage responses to polling for resources is described with reference to FIGS. 12A-12B. In one example, this logic is invoked when responses to requests for resource data are processed on a periodic basis and performed by RS.

Referring to FIG. 12A, for each resource represented in a response to polling for resource information, STEP 1200, the BR structures are used to determine if there exists one or more associated RG(s), STEP 1202. If the resource has changed state or if there exist properties of the resource which may impact the state of a RG, INQUIRY 1204, resource information and RG identification for subsequent processing is saved, STEP 1206. Otherwise, processing continues at STEP 1202.

When all resources having a response have been evaluated, the saved list of potentially impacted RG(s) is used to determine RG state impact. For each RG potentially being impacted, STEP 1208, the RG state aggregation rule is accessed, STEP 1210. Using the impact pairings for the RG, saved values for resource states and values of properties, the RG state is reevaluated, STEP 1212. This evaluation process is accomplished, in one embodiment, by combining the values of the various properties specified in the aggregation rule, according to the mathematical expression given in the rule. For example, if a RG was defined having two member resources and, if a resource changed to an unavailable state, the RG aggregated state rule could specify the RG should be evaluated as degraded if either of the two member resources becomes unavailable. As another example, a RG could be defined with three members all of which must be available for the RG to be considered available. As an example, three CICS resources must be available for the RG to be available. Additionally, each CICS resource has a composed state which specifies that the CICS resource is to be considered degraded if it is not processing 100 transactions/sec. Should any of the three CICS regions surface an event indicating the transaction/sec property has a value less than 100, the CICS region would be evaluated as degraded resulting in the RG it is associated with also being evaluated as degraded.

For each RG having changed state, STEP 1214, an assessment of RG state impact on resources is made. The impact pairings reflecting RG/resource effect are selected, STEP 1216. For each resource potentially impacted by the RG state change, STEP 1218 (FIG. 12B), resource state is recalculated from the saved, new RG state and resource property/values returned from the poll cycle, STEP 1220. Changes in resource state are recorded for subsequent processing. This concludes poll response processing.

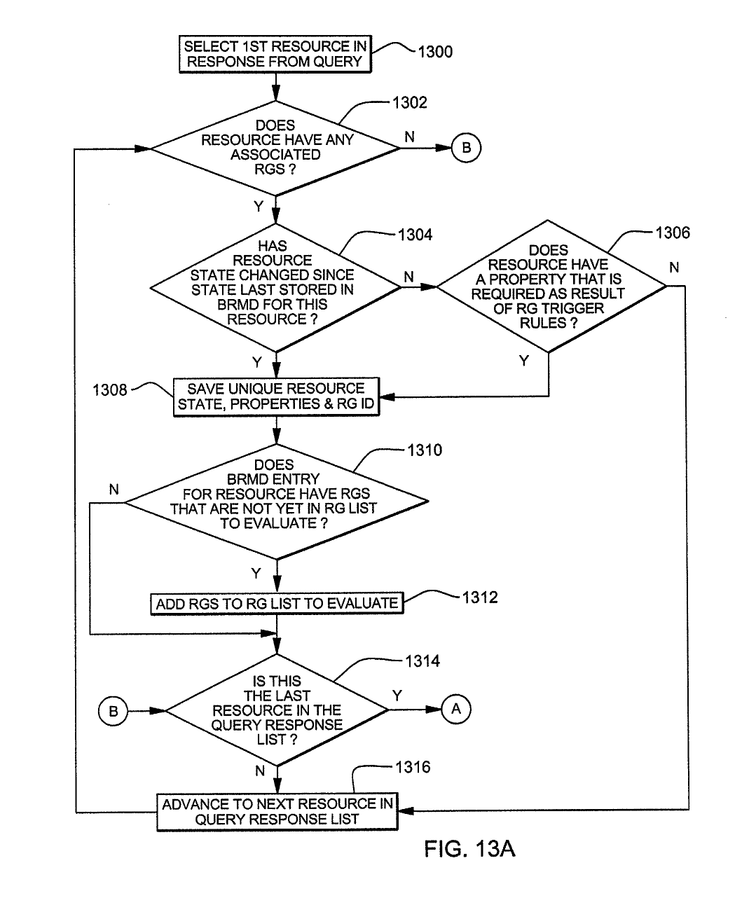

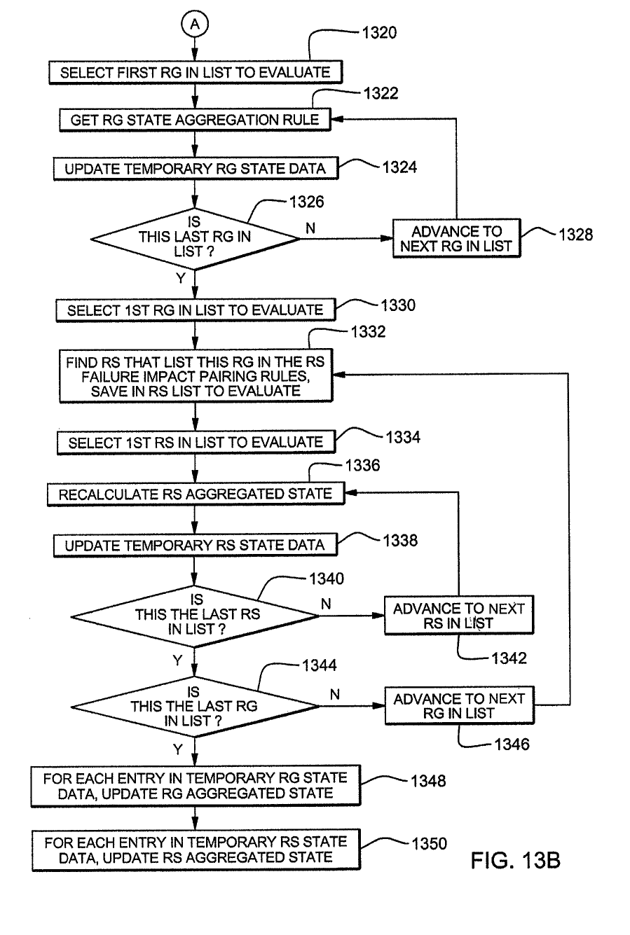

In performing recovery processing and asynchronous collection of information from resources, a query of resource state and property values is performed. The following logic may be introduced in that processing to support RG state having impact on RS state. For example, one embodiment of the logic associated with updating a RG, as well as a RS, after response to a query, is described with reference to FIGS. 13A-13B.

Referring to FIG. 13A, for each resource represented in the response to query, processing evaluates whether the RG state is to be changed, and what impact that change might have on a related RS. In STEP 1300, the first resource in the response from the query is selected. Next, the resource is evaluated to detect whether there are any associated RGs, STEP 1302. If there are no related RGs, then processing continues to INQUIRY 1314, described below. However, if there is at least one related RG, processing continues to evaluate whether the resource state has changed since the state was last stored in the BRMD entry for this resource, INQUIRY 1304, or if the resource has a property that is required as a result of the RG trigger rules, INQUIRY 1306. If neither of these conditions is true, processing continues to advance to the next resource in the list returned in response to query, STEP 1316. If one or both of these conditions is true, then processing continues to STEP 1308 to save the unique resource id, its state, the resource properties and the id of the associated RGs.

Further, a determination is made as to whether the BRMD entry for the resource has RGs that are not yet in the RG list to evaluate, INQUIRY 1310. If so, the RGs are added to the RG list to evaluate, STEP 1312. Next or if there are no RGs to be added, a determination is made as to whether this is the last resource in the list of resources in the response from the query, INQUIRY 1314. If this is not the last resource, the next resource is selected, STEP 1316, and the flow returns to STEP 1302 to continue processing until all resources in the list are evaluated.

When all the resources in the response from query are evaluated, INQUIRY 1314, the RG aggregated state is determined, starting at STEP 1320 (FIG. 13B). For instance, the first RG in the RG list to evaluate is selected, where the RG list to evaluate is determined in above STEPS 1300-1316. After the first RG is selected, the RG state aggregation rules are retrieved from the RG table, STEP 1322, and temporary RG state data is updated, STEP 1324. For instance, the RG state is built based on the obtained rules and the values of the properties returned from the query.

Next, a determination is made as to whether this is the last RG in the list to be evaluated, INQUIRY 1326. If this is not the last RG in the list, the next RG in the list is selected, STEP 1328, and processing returns to STEP 1322. This continues until all the RGs are processed, and INQUIRY 1326 evaluates true for the last RG.

In the next sequence of steps, the state of any RS impacted by the altered RG states is evaluated. The first RG in the list is selected, STEP 1330. Then, any RS that lists the selected RG in the RS Failure Impact Pairing rules is saved into a RS list to evaluate, STEP 1332. Thereafter, the first RS in that list is selected, STEP 1334, and the RS aggregated state is recalculated from, for instance, the state aggregation rules, STEP 1336. The temporary RS state data is then updated, STEP 1338. Next, an evaluation is made as to whether this is the last RS in the list for this RG, INQUIRY 1340. If not, the next RS is selected, STEP 1342, and processing cycles back to STEP 1336. However, if this is the last RS in the list for this RG, INQUIRY 1340, then a determination is made as to whether this is the last RG in the list, INQUIRY 1344. If not, the next RG is selected, STEP 1346, and processing cycles back to STEP 1332 to process the one or more Recovery Segments associated with the next RG.

When all the RGs in the list to evaluate have their associated RS assessed and updated, processing continues to STEPs 1348 and 1350 to update the RG aggregated state data from the temporary RG state data, and to update the RS aggregated state data from the temporary RS state data. As one example, this is performed using a short transaction.

Considerations for Co-Location when Starting Resources

Information about resource pairings is used to determine when a given resource is required to co-locate or required to not co-locate with another resource. The ordering information is used when an operation that requires or desires the move of a resource to a different hosting container is chosen as the recovery operation. Once such an operation is chosen, the co-location pairings for that resource are evaluated in choosing a target for the move. There are two basic options for co-location: attracts and repels.

These types of rules about co-location are expected to employ a conditional expression of when they should be exercised. BR uses the runtime state of the environment to assess whether a co-location requirement is to be enforced. One simple example is: a co-location requirement may exist between two resources, but only when the state of one resource is operational.

Selection from a RG when Starting Resources

During the process to evaluate co-location pairings, when the BR Manager selects a target resource to accommodate a move to a new hosting environment is required, the RG is evaluated to choose a viable candidate. Candidates are chosen, in one example, based on state of the individual resource being considered as a target, along with the overall set of co-location pairings for those resources which are to be recovered. For example, if 10 resources are to be moved to targets, the requirements of the set as a whole are evaluated and optimized, with respect to which resources have multiple targets, which have a more restricted list of alternate environments, etc.

One example of a technique for such a selection is described below. One input includes an operations list where each entry is a pair of resource and resource operations specifications. A second input determines if the selection is of a computer system on which to start an operating system (OS) or of an operating system on which to start a subsystem (e.g., APP, such as DB2 or CICS). The routine utilizes co-location pairings and RG definitions retrieved from the BRRD table and the RG table. For co-location pairings, there may exist, for example:
Operating system attracted to computer system or RG of computer systems.
CICS attracted to operating system or RG of operating systems.
DB2 attracted to operating system or RG of operating systems.
CICS attracted to CICS or DB2.
DB2 attracted to CICS or DB2.
Operating system attracted to operating system (should be on a computer system hosted by the same central electronics complex (CEC) as another operating system).
Operating system repelled from operating system (should not be on a computer system that is hosted on the same CEC).
CICS repelled from CICS or DB2.
DB2 repelled from CICS or DB2.

In the above example, CICS and DB2 are two examples of subsystems. However, other subsystems or applications may be employed.

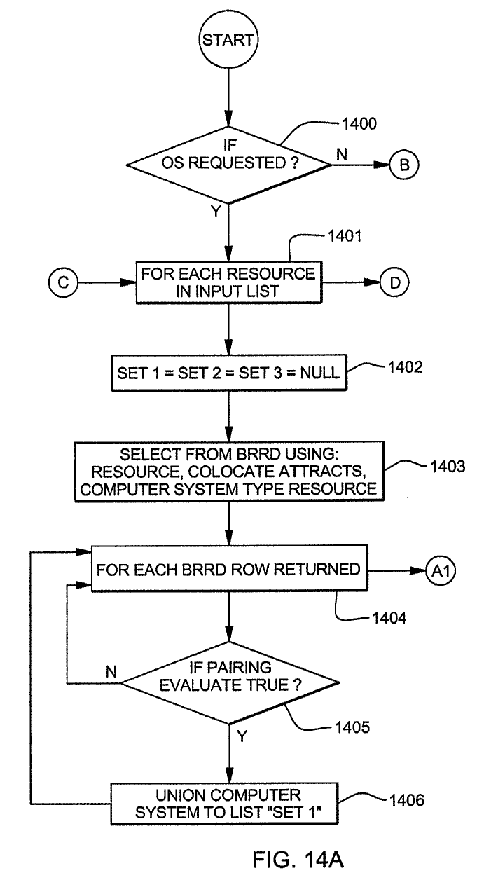

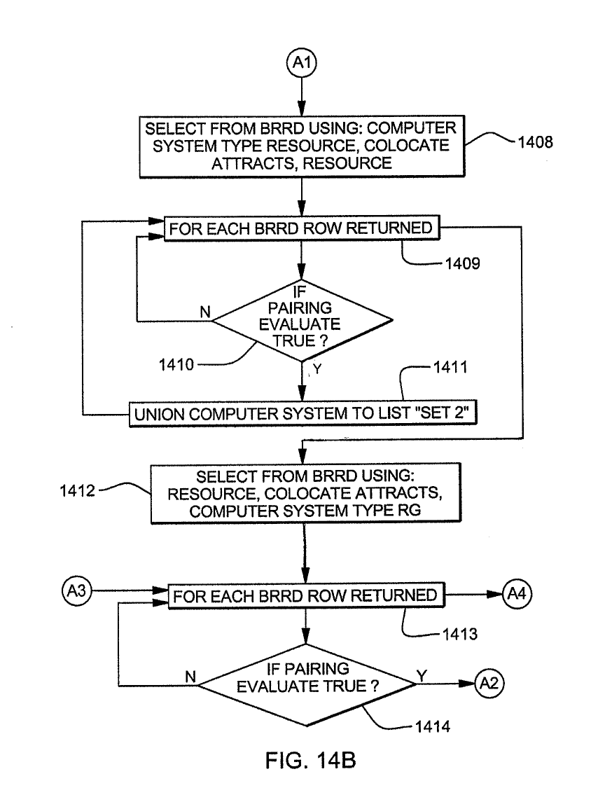

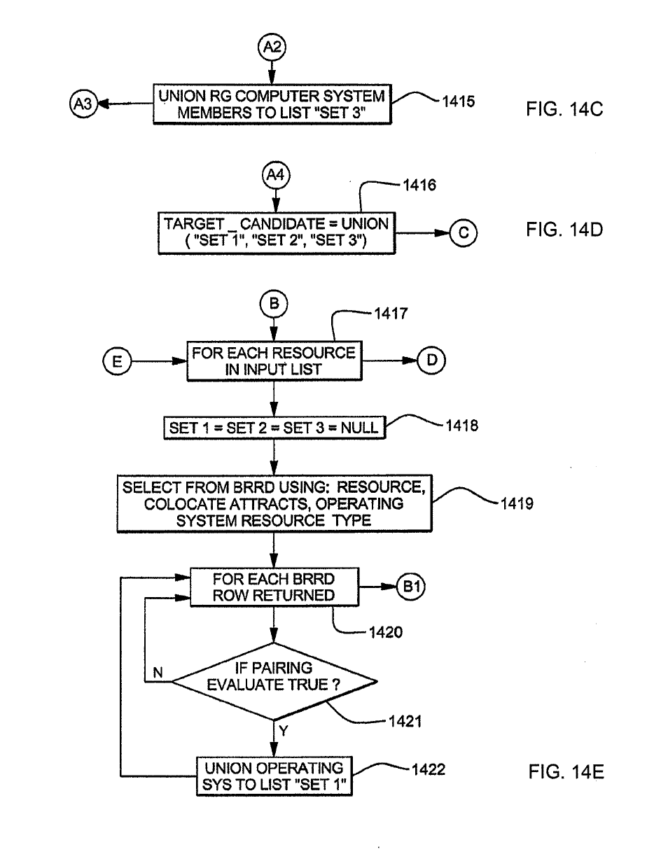

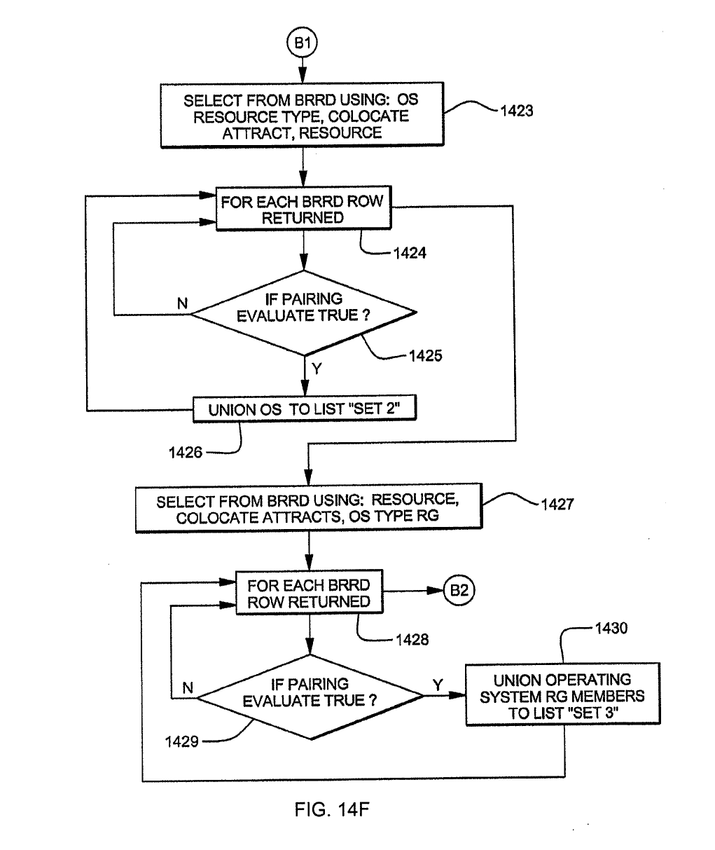

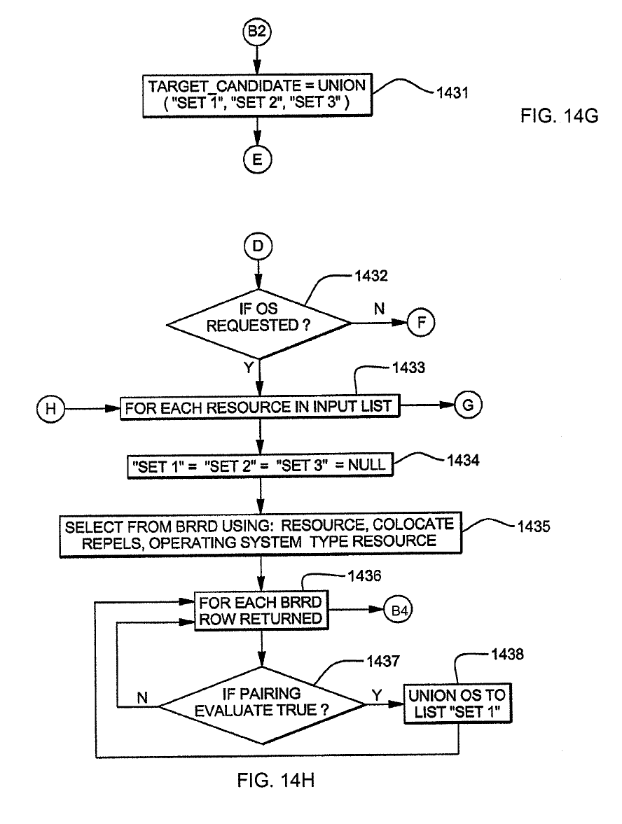

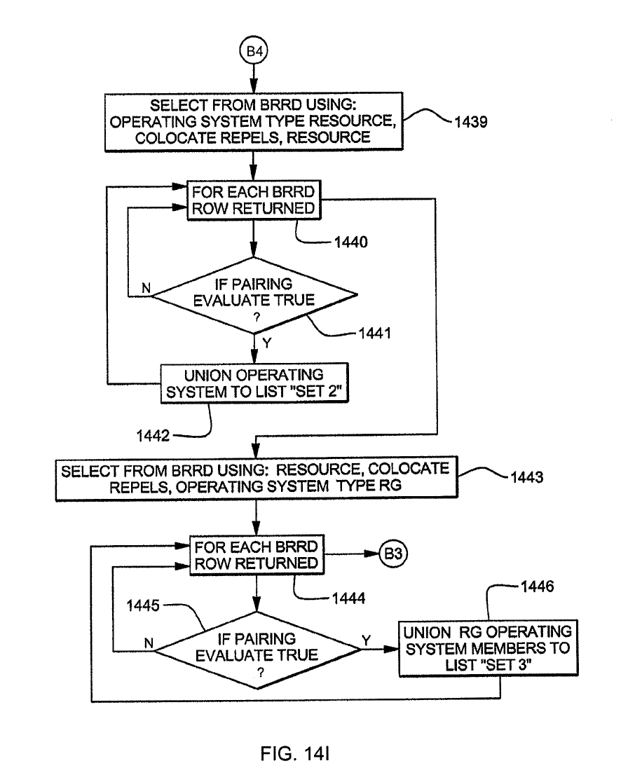

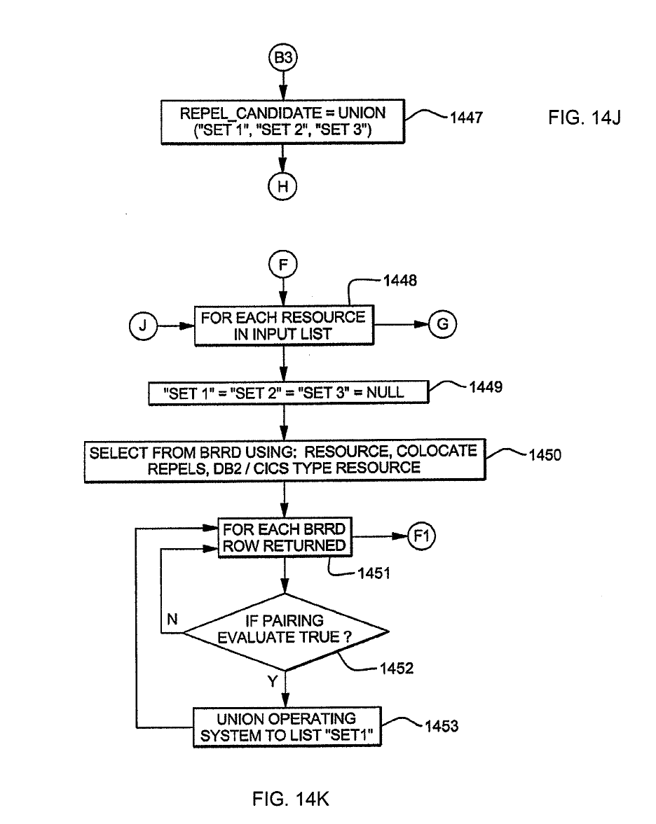

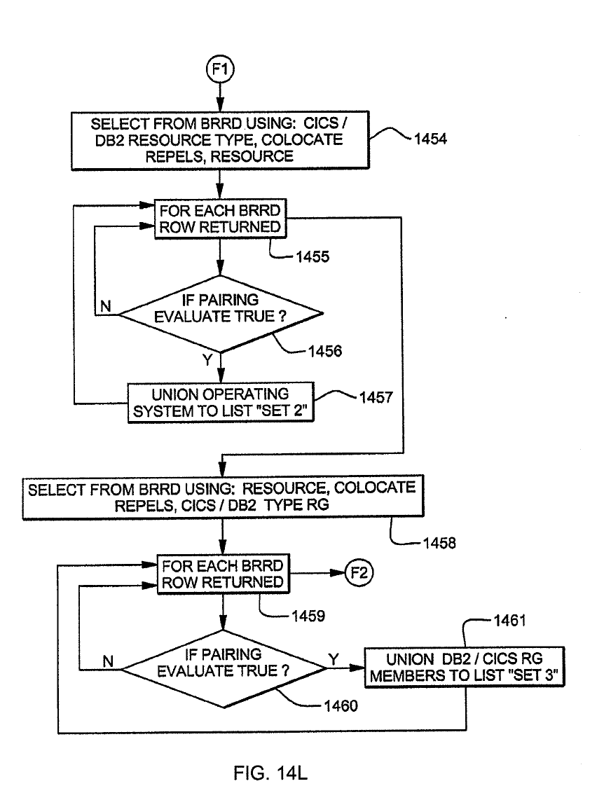

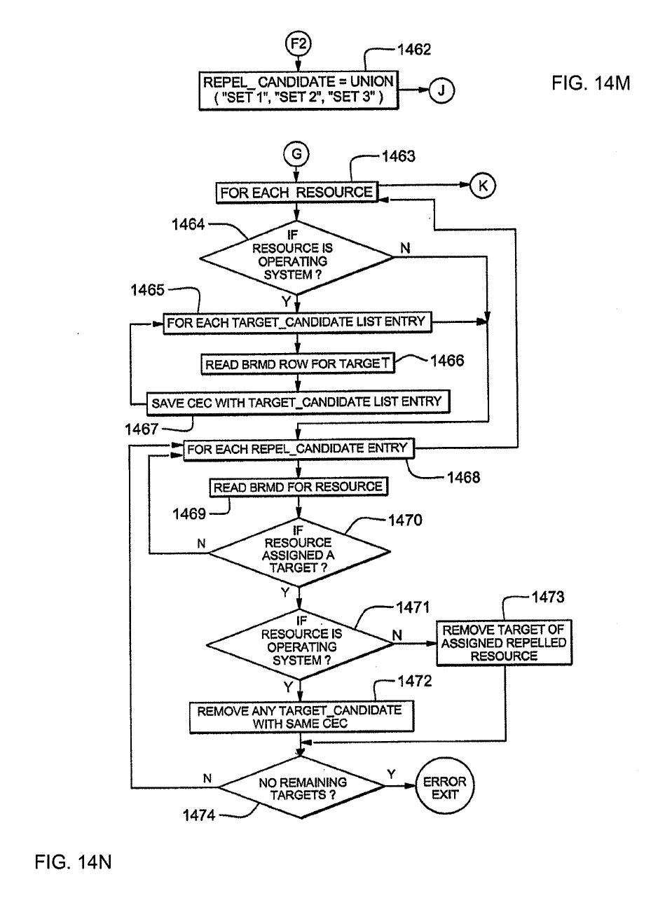

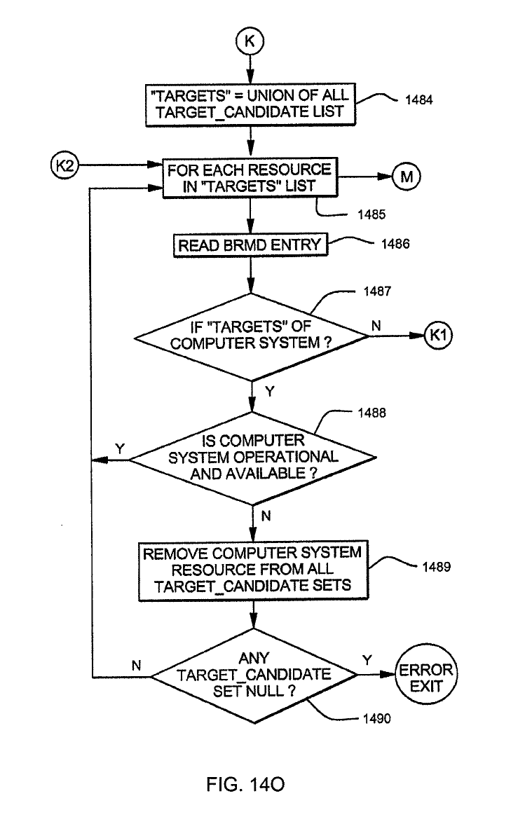

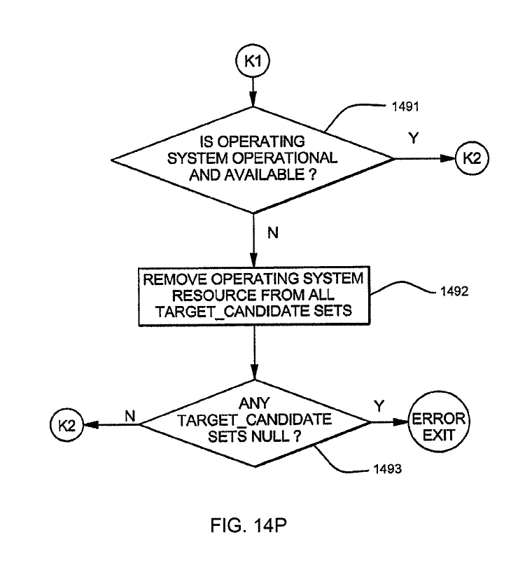

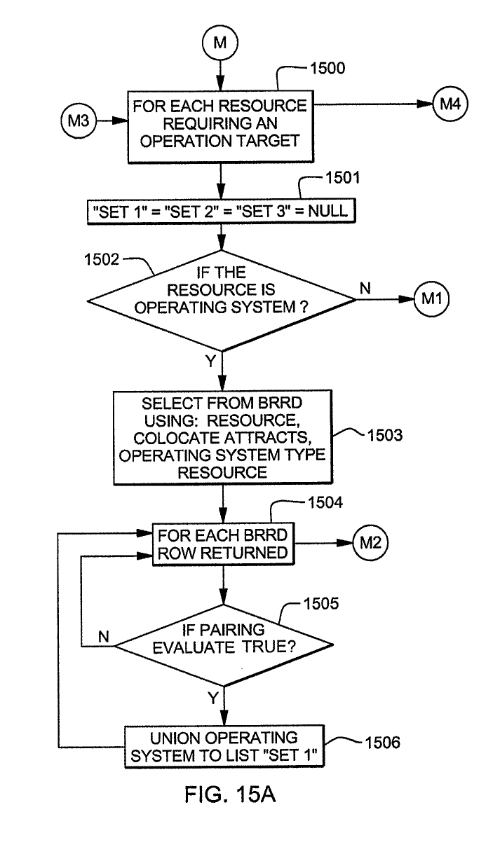

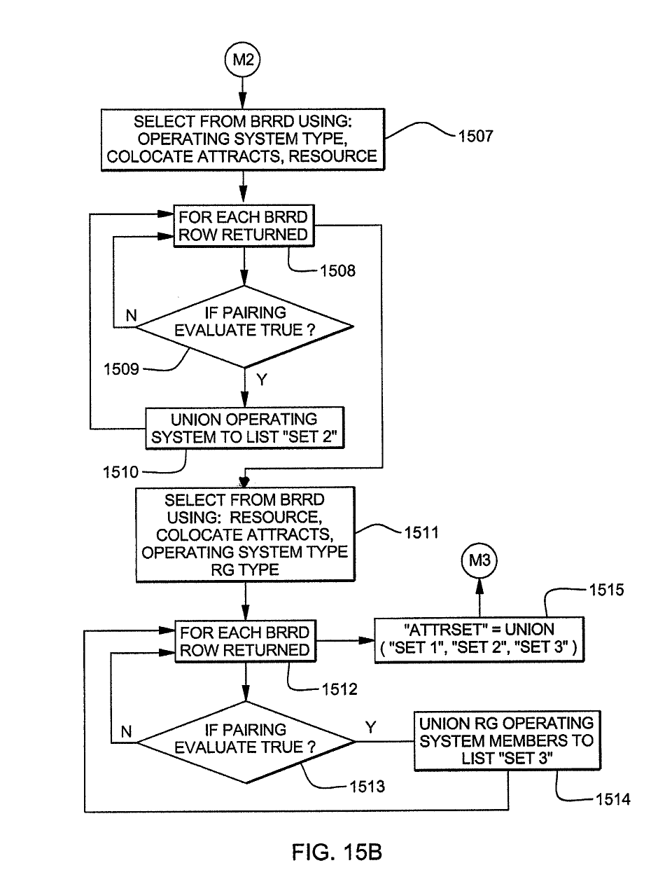

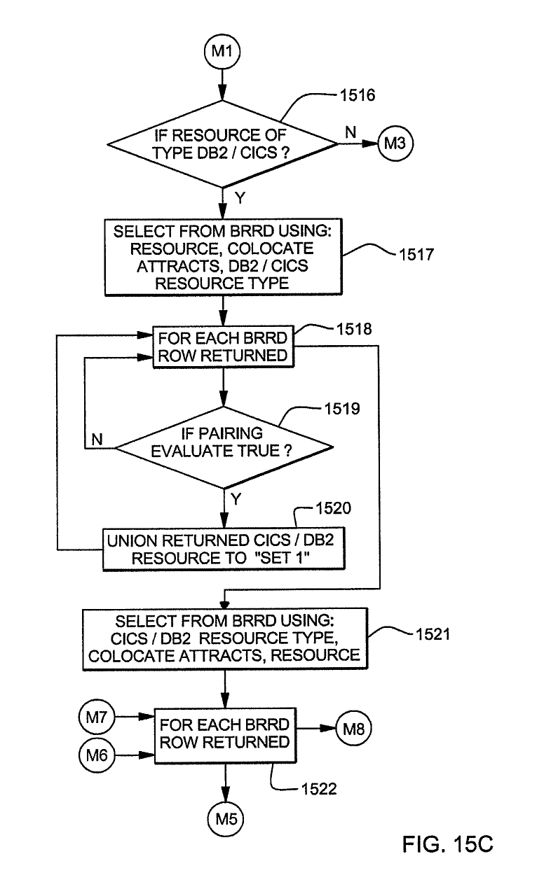

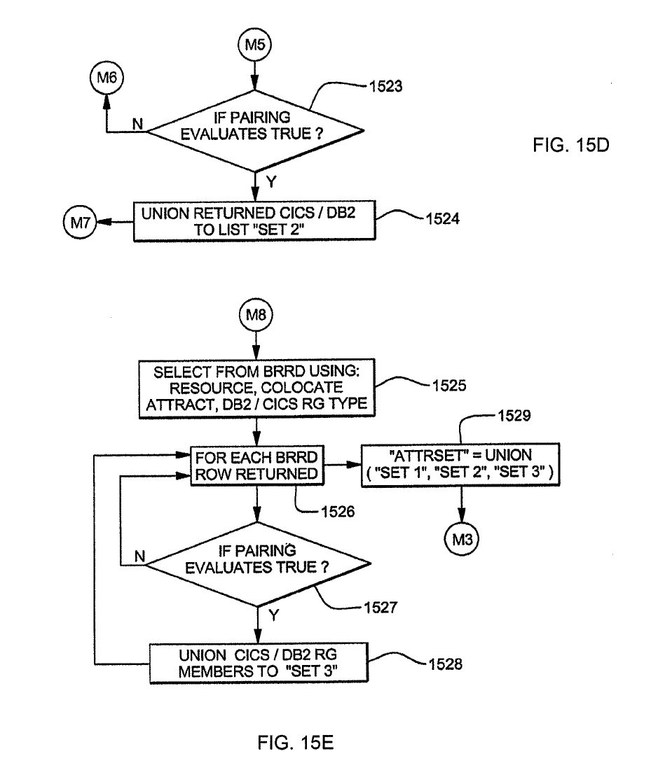

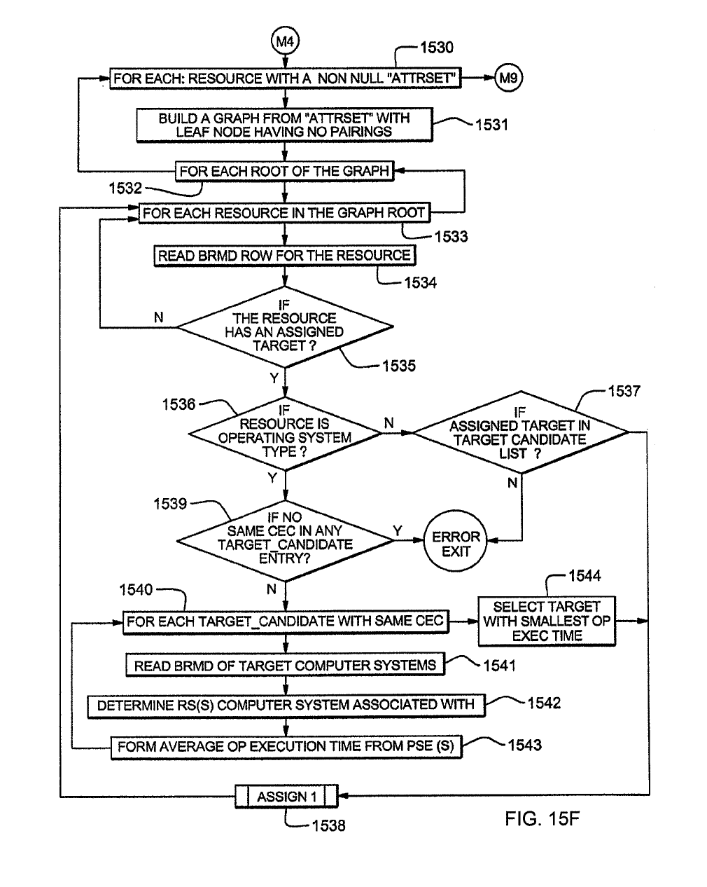

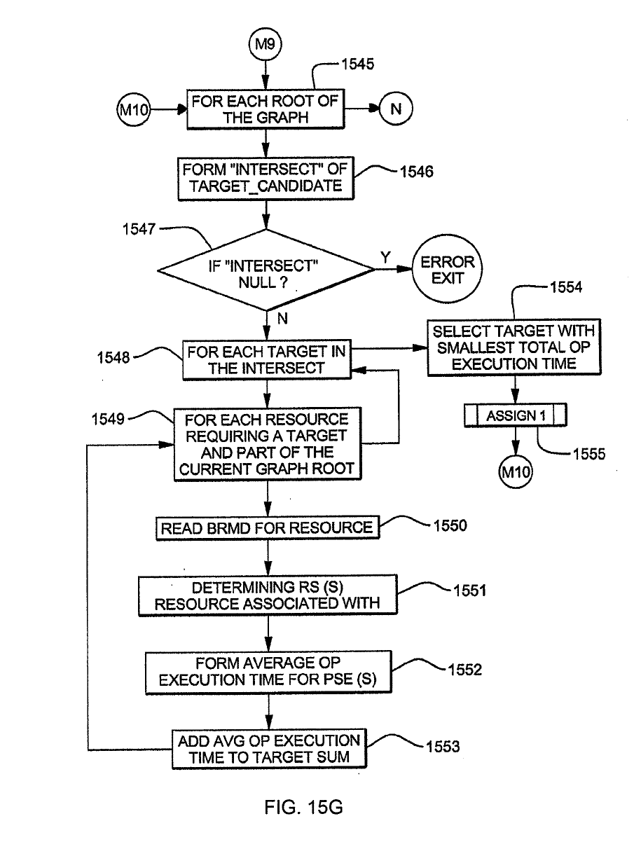

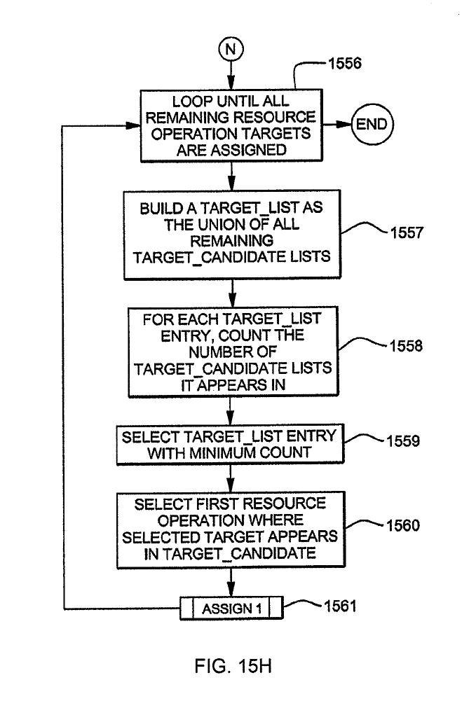

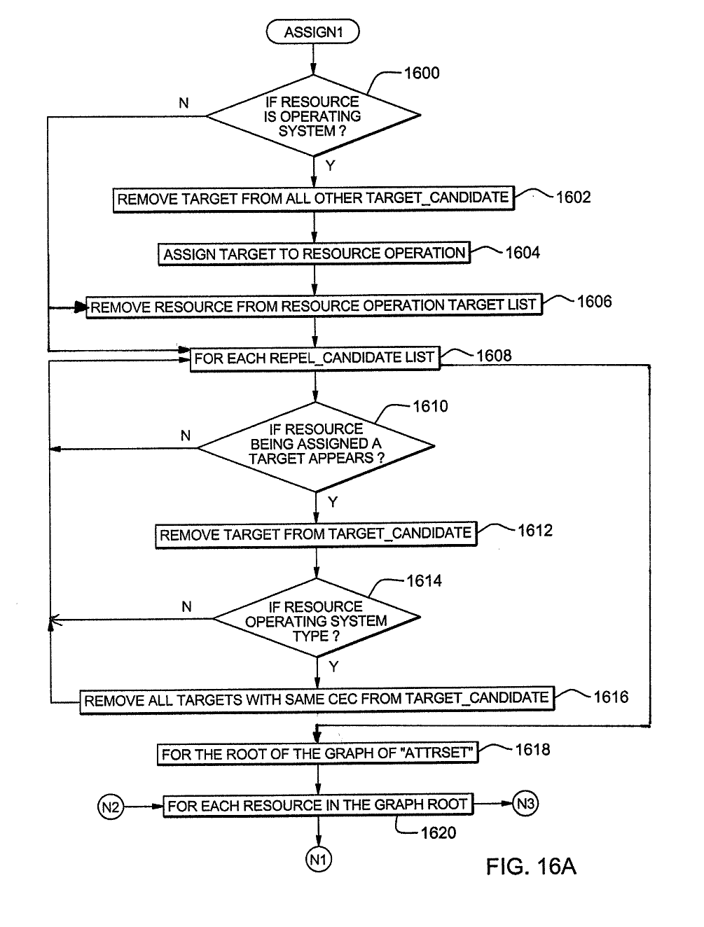

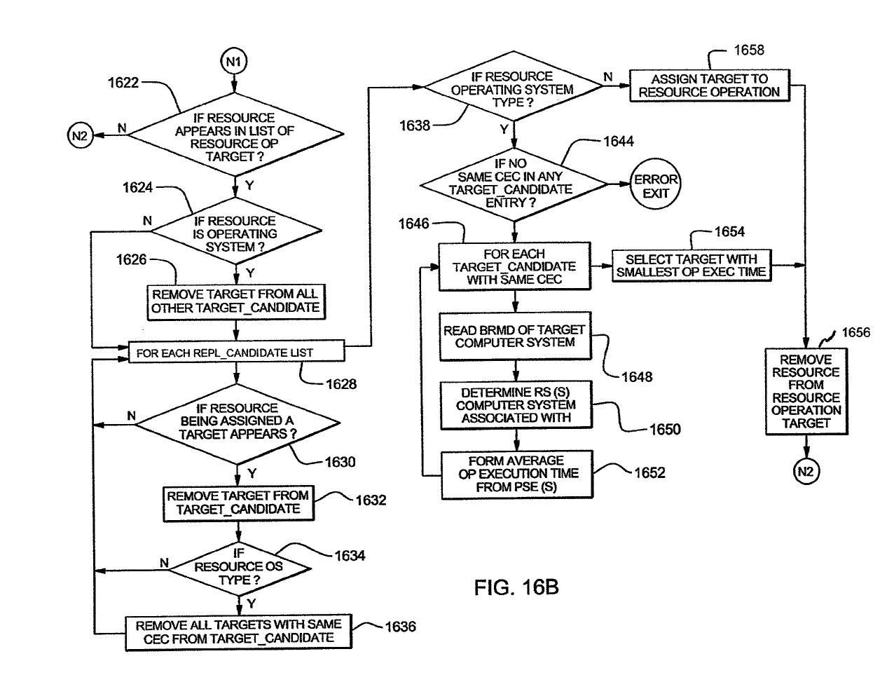

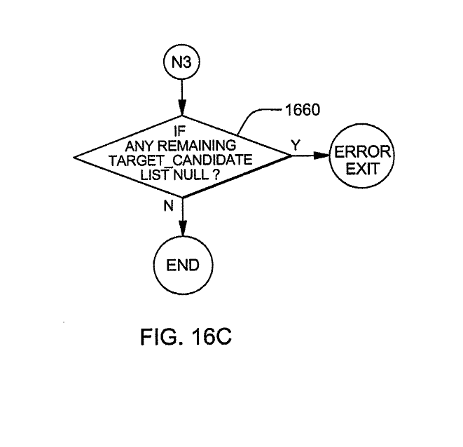

One embodiment of the logic associated with finding a target is described with reference to FIGS. 14A-14P and FIGS. 15A-15H. As one example, this logic is invoked when a recovery process is being built in which the selected recovery operation results in starting an operating system or application (e.g., CICS or DB2) on a target (e.g., either a computer system or operating system target). In one example, the logic is invoked and performed by the BRM component of the BR System, unless otherwise noted. In summary, the technique progresses through the following steps:
Build a list of target candidates driven off attracts co-location pairings for a subsystem (e.g., DB2 or CICS) to an operating system, or an operating system to a computer system (e.g., STEPS 1400-1431, FIGS. 14A-14H).
Remove from the target candidate set any resource based on repel co-locate pairings (e.g., STEPS 1432-1474, FIGS. 14H-14N).
Remove from the target candidate set any resource not available and operational (e.g., STEPS 1484-1493, FIGS. 14O-14P).
Enforce attracts co-locate pairings with some resource assigned a target driven off attracts co-location pairings for DB2 or CICS to DB2 or CICS, or operating system to operating system (e.g., STEPS 1500-1538, FIGS. 15A-15F).
Enforce attracts co-location pairings where no target is assigned to any resource by minimizing the operation execution time for the set of resource operations requiring a target (e.g., STEPS 1545-1555, FIG. 15G)).
The technique concludes by assigning targets for resource operations based on iteratively assigning targets to resource operations where the target with the least number of potentially assigned operations is selected first (e.g., STEPS 1556-1561, FIG. 15H).
The subroutine “assign1” for assigning a target to a resource operation is described with reference to FIGS. 16A-16C.

Referring initially to FIG. 14A, a determination is made as to whether a target for an operating system start is requested, INQUIRY 1400. If a target for an OS is being requested, a target candidate list of computer systems is built. In one example, the collection of target candidates is accumulated in three lists, set1, set2, set3, which are combined at the end of processing to locate target candidates. A target_candidate list is built for each resource in the input list. This technique requires, in one example, co-locate attract pairings to be in place to manage the target of an operation—that is the only way in this example in which entries are placed in the target_candidate list for each resource. An extension to this technique which would not require co-locate attracts pairings would be to place any available and operational target in the target_candidate list, if no co-locate attract pairings existed.

For building a target candidate list of computer systems, pairings are selected from the BRRD in three sets of steps. In the first set of steps, processing cycles through the input list of resources until all have been evaluated, STEP 1401. Initially, the three target candidate lists are set to null, STEP 1402. Then, a first set of target candidate resources is created by selecting BRRD rows for which there exist a co-locate, attracts pairing identifying the input resource as the first resource and the computer system resource type as the second pairing component, STEP 1403. For each BRRD row returned, STEP 1404, the associated pairing is evaluated, STEP 1405. For those pairings which are currently valid, the computer system returned as part of the BRRD row is unioned with list “set1”, STEP 1406.

A second set of target candidate resources is created by selecting BRRD rows for which there exist a co-locate, attracts pairing identifying a computer system resource type as the first pairing component and the input resource as the second pairing component, STEP 1408 (FIG. 14B). For each BRRD row returned, STEP 1409, the associated pairing is evaluated, STEP 1410. For those pairings which are currently valid, the computer system returned as part of the BRRD row is unioned with list “set2”, STEP 1411.

A third set of target candidate resources is created by selecting BRRD rows for which there exist a co-locate, attracts pairing identifying the input resource as the first resource and a computer system RG resource type as the second pairing component, STEP 1412. For each BRRD row returned, STEP 1413, the associated pairing is evaluated, STEP 1414. For those pairings which are currently valid, the computer system(s) returned as part of the RG are unioned with list “set3”, STEP 1415 (FIG. 14C).

When all three sources of target candidates have been evaluated, a composite target_candidate set is formed from the union of the three sources, STEP 1416 (FIG. 14D). Thereafter, the next resource is processed, STEP 1401. When all input operating system resource(s) have been evaluated, processing continues to evaluate co-locate, repels pairings beginning at INQUIRY 1432 (FIG. 14H), as described below.

Returning to INQUIRY 1400, if a target for an OS is not requested, then a request is being made for a target for a subsystem start. Thus, a target candidate list of operating systems is built. To build a target candidate list of operating systems, each input resource is evaluated, STEP 1417 (FIG. 14E). Initially, set1, set2 and set3 are initialized to NULL, STEP 1418. Then, the pairings are selected from the BRRD in three steps. A first set of target candidate resources is created by selecting BRRD rows for which there exist a co-locate, attracts pairing identifying the input resource as the first resource and an operating system resource type as the second pairing component, STEP 1419. For each BRRD row returned, STEP 1420, the associated pairing is evaluated, STEP 1421. For those pairings which are currently valid, the operating system resource returned as part of the BRRD row is unioned with list “set1”, STEP 1422.

A second set of target candidate resources is created by selecting BRRD rows for which there exist a co-locate, attracts pairing identifying an operating system resource type as the first pairing component and the input resource as the second pairing component, STEP 1423 (FIG. 14F). For each BRRD row returned, STEP 1424, the associated pairing is evaluated, INQUIRY 1425. For those pairings which are currently valid, the operating system resource returned as part of the BRRD row is unioned with list “set2”, STEP 1426.

A third set of target candidate resources is created by selecting BRRD rows for which there exist a co-locate, attracts pairing identifying the input resource as the first resource and an operating system RG resource type as the second pairing component, STEP 1427. For each BRRD row returned, STEP 1428, the pairing is evaluated, INQUIRY 1429. For those pairings which are currently valid, the operating system resource(s) returned as part of the RG are unioned with list “set3”, STEP 1430.

When all three sources of target candidates have been evaluated, a composite target_candidate set is formed from the union of the three sources, STEP 1431 (FIG. 14G). Thereafter, the next resource is processed, STEP 1417. When all input subsystem resource(s) have been evaluated, processing continues to evaluate co-locate, repels pairings at INQUIRY 1432 (FIG. 14H).

Repel processing occurs in two phases. In a first phase, a list of operating system(s) which repel the operating system for which a target is required or a list of subsystems which repel the subsystem for which a target is required is created. From the repel list, if there is a target assigned to the operating system or subsystem which repels the resource requiring a target, the assigned target of the repelling resource is removed from the target candidate list for the resource for which a start command target is being assigned.

At INQUIRY 1432, target candidates are removed from the list based on co-locate repel pairings. Initially, a determination is made as to whether a target for an operating system start is being made, INQUIRY 1432. If the target for an operating system start is being requested, then a repel list of operating systems is to be built.

For building a repel list of computer systems, pairings are selected from the BRRD in three steps. Processing cycles through the input list of resources until all have been evaluated, STEP 1433. Initially, set1, set2 and set3 are initialized to null, STEP 1434, and then a first set of repel resources is created by selecting BRRD rows for which there exist a co-locate, repels pairing identifying the input resource as the first resource and operating system resource type as the second pairing component, STEP 1435. For each BRRD row returned, STEP 1436, the associated pairing is evaluated, STEP 1437. For those pairings which are currently valid, the operating system returned as part of the BRRD row is unioned with list “set1”, STEP 1438.

A second set of repels resources is created by selecting BRRD rows for which there exist a co-locate, repels pairing identifying an operating system resource type as the first pairing component and the input resource as the second pairing component, STEP 1439 (FIG. 14I). For each BRRD row returned, STEP 1440, the associated pairing is evaluated, INQUIRY 1441. For those pairings which are currently valid, the operating system returned as part of the BRRD row is unioned with list “set2”, STEP 1442.

A third set of repels resources is created by selecting BRRD rows for which there exist a co-locate, repels pairing identifying the input resource as the first resource and an operating system RG resource type as the second pairing component, STEP 1443. For each BRRD row returned, STEP 1444, the associated pairing is evaluated, INQUIRY 1445. For those pairings which are currently valid, the operating system(s) returned as part of the RG are unioned with list “set3”, STEP 1446.

When all three sources of repel candidates have been evaluated, a composite repel_candidate set is formed from the union of the three sources, STEP 1447 (FIG. 14J). Thereafter, the next resource is processed, STEP 1433 (FIG. 14H). When all of the OS resources have been processed, the flow continues at STEP 1463 (FIG. 14N), as described below.

Returning to INQUIRY 1432 (FIG. 14H), if a target for an OS is not requested, a repel list of subsystems is built. For building a repel list of subsystems, each input resource is evaluated, STEP 1448 (FIG. 14K). Initially, set1, set2 and set3 are initialized to null, STEP 1449. Then, pairings are selected from the BRRD in three steps. A first set of repels resources is created by selecting BRRD rows for which there exist a co-locate, repels pairing identifying the input resource as the first resource and DB2 or CICS resource type as the second pairing component, STEP 1450. For each BRRD row returned, STEP 1451, the associated pairing is evaluated, INQUIRY 1452. For those pairings which are currently valid, the DB2 or CICS resource returned as part of the BRRD row is unioned with list “set1”, STEP 1453.

A second set of repels resources is created by selecting BRRD rows for which there exist a co-locate, repels pairing identifying a DB2 or CICS resource type as the first pairing component and the input resource as the second pairing component, STEP 1454 (FIG. 14L). For each BRRD row returned, STEP 1455, the associated pairing is evaluated, INQUIRY 1456. For those pairings which are currently valid, the DB2 or CICS resource returned as part of the BRRD row is unioned with list “set2”, STEP 1457.

A third set of repels resources is created by selecting BRRD rows for which there exist a co-locate, repels pairing identifying the input resource as the first resource and a DB2 or CICS RG resource type as the second pairing component, STEP 1458. For each BRRD row returned, STEP 1459, the associated pairing is evaluated, INQUIRY 1460. For those pairings which are currently valid, the DB2 or CICS resource(s) returned as part of the RG are unioned with list “set3”, STEP 1461.

When all three sources of repel candidates have been evaluated, a composite repel_candidate set is formed from the union of the three sources, STEP 1462 (FIG. 14M). Further, the next resource is processed, STEP 1448 (FIG. 14K).

When each resource in the input list is processed, STEP 1433 (FIG. 14H) or STEP 1448 (FIG. 14K), processing continues with STEP 1463 (FIG. 14N), in which from the repel_candidate list for each resource potential targets for operations on each resource are removed.

For operating system type resources, INQUIRY 1464, any computer system image on the same CEC as a repelled operating system is to be removed from the target_candidate list. Determination of the computer system to CEC association begins by selecting each computer system in the target_candidate list, STEP 1465. The BRMD row is retrieved, STEP 1466, from which the associated CEC is extracted and saved with the target_candidate list entry, STEP 1467, for the associated computer system.

For each resource in the repel_candidate list of the resource, STEP 1468, the associated BRMD entry is retrieved, STEP 1469. If the repelled resource does not have an assigned target, INQUIRY 1470, the next repelled resource is processed. However, if the repelled resource has a target, a determination is made as to whether operating system resources are being assigned a target computer system, STEP 1471. If so, all target_candidate list entries with the same CEC as the CEC assigned to the repelled operating system instance are removed as candidates, STEP 1472.

Returning to INQUIRY 1471, for subsystems (e.g., CICS or DB2) having a repelled resource with an assigned target, INQUIRY 1470, that target is removed, if it exists, from the target_candidate list of the resource being processed, STEP 1473.

If a candidate target is removed resulting in no viable target resources, INQUIRY 1474, an error is indicated and the routine exited, in this example.

In the next phase of processing, potential targets which are not operational are removed from the target_candidate list of each resource. Initially, a composite of potential targets for all resources is formed, STEP 1484 (FIG. 14O). For each resource in the composite targets list, STEP 1485, the status of the target resource is retrieved from the BRMD, STEP 1486.

If the resource type of “targets” is computer system, INQUIRY 1487, a determination is made as to whether the computer system is operational and available (having no associated operating system), INQUIRY 1488. If the computer system is not operational or not available (has an associated operating system), it is removed from all target_candidate sets for all resources, STEP 1489. If any target_candidate set becomes null as a result, INQUIRY 1490, an error response is generated and processing exits, in this example.

Returning to INQIURIES 1488 and 1490, if INQUIRY 1488 evaluates as true or INQUIRY 1490 evaluates as false, processing continues with STEP 1485.

Returning to INQUIRY 1487, if the resource type of “targets” is an operating system, a determination is made if the operating system is operational and available, INQUIRY 1491 (FIG. 14P). If the operating system is not operational and available, it is removed from all target_candidate sets for all resources, STEP 1492. If any target_candidate set becomes null as a result, INQUIRY 1493, an error response is generated and processing exits, in this example.

However, if the operating system is operational and available, INQUIRY 1491, or if the target candidate list is not null, INQUIRY 1493, processing continues with STEP 1485 (FIG. 14O).

When all non viable targets have been removed, processing continues by enforcing co-locate attracts pairings between subsystems and between operating systems. Making an assignment for a target utilizes a common routine, “assign1”, described below. In performing the assignment of a target for a resource operation through “assign1”, the environment may be changed due to co-location pairings. The “assign1” routine operates with this routine to enforce co-locate pairings ensuring that resources requiring a target that have any attracts relationship, directly or implied by a chain of attracts relationships, are targeted to the same resource. When “assign1” completes the association of a target with a resource operation, related co-locate repels relationships are enforced by removing the target from any target_candidate set of a resource identified in a co-locate repels pairing.

Processing continues with processing of attracts pairings, an example of which is described with reference to FIGS. 15A-15H. Referring to FIG. 15A, an “attrset” list of resources is created for each resource requiring a resource operation target. For each resource, STEP 1500, initially, lists used to build the “attrset” are set to null, STEP 1501. Thereafter, if the resource is requiring a target operating system, STEP 1502, pairings matching the resource, co-locate attracts and operating system type resource are selected from the BRRD, STEP 1503. For each BRRD row returned, STEP 1504, the associated pairing is evaluated, INQUIRY 1505. For those pairings which are currently valid, the operating system resource returned is unioned with list “set1”, STEP 1506.

A second attracts set is selected from the BRRD using operating system type resource, co-locate attracts and the resource, STEP 1507 (FIG. 15B). For each BRRD row returned, STEP 1508, the associated pairing is evaluated, INQUIRY 1509. For those pairings which are currently valid, the operating system resource returned is unioned with list “set2”, STEP 1510.

A third attracts set is selected from the BRRD using the resource, co-locate attracts and operating system RG type, STEP 1511. For each BRRD row returned, STEP 1512, the associated pairing is evaluated, INQUIRY 1513. For those pairings which are currently valid, the operating system members of the RG are unioned with list “set3”, STEP 1514.

The attract set, “attrset” for the resource is formed from the union of “set1”, “set2” and “set3”, STEP 1515.

Returning to INQUIRY 1502, if the resource for which a target is requested is not an operating system, processing continues with INQUIRY 1516 (FIG. 15C). At INQUIRY 1516, if the resource is of type subsystem (e.g., DB2 or CICS), a first attracts set is selected from the BRRD using the resource, co-locate attracts and DB2 or CICS resource type, STEP 1517. For each BRRD row returned, STEP 1518, the associated pairing is evaluated, INQUIRY 1519. For those pairings which are currently valid, the DB2 or CICS resource returned is unioned with list “set1”, STEP 1520.

A second attracts set is selected from the BRRD using DB2 or CICS resource type, co-locate attracts and the resource, STEP 1521. For each BRRD row returned, STEP 1522, the associated pairing is evaluated, INQUIRY 1523 (FIG. 15D). For those pairings which are currently valid, the DB2 or CICS resource returned is unioned with list “set2”, STEP 1524.

A third attracts set is selected from the BRRD using the resource, co-locate attracts and DB2 or CICS RG type, STEP 1525 (FIG. 15E). For each BRRD row returned, STEP 1526, the associated pairing is evaluated, INQUIRY 1527. For those pairings which are currently valid, the DB2 or CICS RG members are unioned with list “set3”, STEP 1528.

The attract set, “attrset”, for the resource is formed from the union of “set1”, “set2” and “set3”, STEP 1529.

When the “attrset” for each resource has been built, each resource with a non-null attrset is processed, STEP 1530 (FIG. 15F). Using the “attrset”, a graph is constructed using attract pairings for each entry in the “attrset”. The graph is complete when all leaf node resources have no pairings, STEP 1531. This identifies chains of relationships of the type—Resource A attracts Resource B and Resource B attracts Resource C, therefore, Resources A, B and C should co-locate. The purpose of the graph is to determine if any resource in the chain is assigned a target such that the resource now requiring a target is co-located with any member of the chain. The graph may have multiple roots.

For each root of the graph, STEP 1532, and for each resource in the graph root, STEP 1533, the BRMD row for the resource is retrieved, STEP 1534. If the resource has an assigned target, INQUIRY 1535, a determination is made as to whether the processing is of operating system type resources, INQUIRY 1536. If it is not for operating system type resources, but, instead, for subsystem type resources (e.g., CICS or DB2), INQUIRY 1536, and the assigned target is in the target_candidate list of the resource requiring a target for an operation, INQUIRY 1537, the “assign1” routine is invoked to make the assignment, STEP 1538, as described below. Otherwise, an error is indicated and processing exits, in one example.

Returning to INQUIRY 1536, if operating system type resources are being assigned a target, the target_candidate list is searched for any computer system having the same associated CEC, INQUIRY 1539. If no computer system candidate on the same CEC exists, an error is generated and processing exits, in one example.

For each computer system that is a candidate target and is on the same CEC as the operating system with an assigned CEC with a co-locate attracts pairing, STEP 1540, the BRMD of the target computer system is retrieved, STEP 1541. From the BRMD, the RS(s) associated with the computer system are determined, STEP 1542. From the set of PSE(s) associated with the RS(s), operation execution timings are extracted reflecting the time required to start this operating system on the potential target computer system. Operation timings are taken from PSE(s) which match the current date/time interval for measured or customer specified time required to start the operating system on the computer system, STEP 1543. When all potential computer system candidates have been evaluated for operation execution time, a target is selected having the smallest operation execution time, STEP 1544, and the “assign1” routine is invoked, STEP 1538.

In this example, techniques strongly enforce co-locate attracts pairings. If there exists any assigned target in the chain of co-locate attracts pairings, all related resources are targeted to the same resource. An extension to support co-locate attracts pairings, which is advisory and not mandatory, could be made. In doing so, processing would continue if an assigned target is not part of the target_candidate list for the resource. As an example, any available and operational target could be selected as a second choice.

Remaining is a set of resources requiring a target for an operation for which there exists some viable target and for which there exists no unenforced co-locate attracts and/or repels pairings. Processing continues by evaluating each root of the graph to assign a target, STEP 1545 (FIG. 15G). In one example, the determination of where to target the operation for a resource begins by taking the intersect of potential targets for all resources that are part of a common graph root, STEP 1546. If the intersect is null, INQUIRY 1547, there is no one target which will meet the co-locate attracts pairing specification for all resources that are part of the graph root. An error is set and processing exits, in this example.

As before, this particular embodiment of the technique enforces mandatory co-locate attracts pairings. A change in this technique to support advisory co-locate attracts pairings could be made by continuing if the intersect of target candidates is null. An alternative could chose to target the operation for the resource to any of the entries in the target candidate list.

The assignment of a target for the resource operation is selected from the intersect list of viable candidates by determining, for instance, which target has the smallest operation execution duration time for the set of resources requiring a target. For each target in the intersect list, STEP 1548, and for each resource requiring a target that is part of the graph root, STEP 1549, operation execution time data is retrieved. The BRMD row for the resource is read, STEP 1550, in order to locate the RS(s) this resource is associated with, STEP 1551. From operation execution timing for each PSE this resource is currently associated with, an average operation execution time is formed, STEP 1552. The average operation execution time for this resource is added to the total time for all resource operations to be assigned a target, STEP 1553, and saved with the target for later comparison.

When all potential targets have been evaluated for total time to process all operations requiring a target that are part of an attract set, a target is selected having the smallest total operation execution time, STEP 1554, and the “assign1” routine is invoked, STEP 1555. Processing continues at STEP 1545 for each root of the graph. When all roots have been processed, the flow continues at STEP 1556 (FIG. 15H).

For the remaining resource operation target assignments, the target which can satisfy the fewest requests is assigned first. Processing loops until all remaining resource operations requiring a target are assigned, STEP 1556. A target_list is built as the union of the remaining target_candidate lists for resource operations requiring a target assignment, STEP 1557. For each entry in the target_list, a count of the number of target_candidate lists in which it appears is made, STEP 1558. The target_list entry having the smallest count is selected, STEP 1559. The first resource operation having the selected target in its associated target_candidate list, STEP 1560, is assigned a resource operation target via assign1, STEP 1561.

The assign1 routine makes the resource operation target assignment, removes the resource operation from the list requiring assignment, makes assignments for any other resource requiring a target which has attracts co-locate pairing and removes the assigned target from target_candidate lists of resources for which there exists a repel co-locate pairing. If removing a target results in a null target_candidate list, an error is set and the routine exits, in one example. One embodiment of the logic for assigning a target is described with reference to FIGS. 16A-16B. In one example, this logic is performed by the BRM component of the BR system.

Referring to FIG. 16A, if the resource being assigned a target is an operating system, STEP 1600, the target is removed from the other target_candidate lists, STEP 1602, since, in this example, only one operating system can exist on one computer system (as examples, a computer system is a representation of the virtual environment where multiple virtual computer systems may exist on a single physical computer or it is a single physical computer). Further, the operation being processed is assigned the target, STEP 1604, and the list of resource operations requiring a target is updated by removing the entry for the assignment being made, STEP 1606.

Moreover, if the resource being assigned a target is other than an operating system (e.g., a subsystem), INQUIRY 1600, processing continues at STEP 1606, in which the resource is removed from the resource operation target list.

After removing the resource, the flow continues at STEP 1608 to process the repel_candidate lists. At STEP 1608, for all other repel_candidate lists (other than from the resource being assigned a target), if the resource being assigned a target appears in the list, INQUIRY 1610, the assigned target is removed from the target_candidate list, STEP 1612. Subsequent processing at the end of “assign1” will check to see if any target_candidate list became null. Moreover, if an operating system is being assigned a target computer system, INQUIRY 1614, the computer systems associated with the same CEC as the repelled operating system are removed from the target_candidate list, STEP 1616, and processing continues at STEP 1608.

Moreover, if the resource is not in the list, INQUIRY 1610, or is not an operating system, INQUIRY 1614, processing continues at STEP 1608.

Subsequent to processing the other repel_candidate lists, processing continues at STEP 1618. For each root of the graph built during formation of the “attrset” lists, STEP 1618, and for each resource in a root of the graph, STEP 1620, an assessment is made regarding the presence of a resource operation requiring a target, INQUIRY 1622 (FIG. 16B). If a resource in the “attrset” does not require an assignment of an operation target, processing returns to STEP 1620 (FIG. 16A). Otherwise, the resource is assigned the same target.

A check is made to determine if an operating system is being assigned a computer system as a target, INQUIRY 1624 (FIG. 16B). If it is, and since a single operating system is targeted to a computer system, the assigned computer system is removed from the other operating system target_candidate lists, STEP 1626. On the other hand, if the resource being assigned a target is not an operating system, INQUIRY 1624, processing skips STEP 1626.

Since a target assignment is being made due to “attrset” built from co-location expressions, each repelled resource is to have the target removed from it's target_candidate list. For each resource in the repel_candidate list of the resource being assigned a target, STEP 1628, if the resource being assigned a target appears in the list, INQUIRY 1630, the assigned target is removed from the target_candidate list of the repelled resource, STEP 1632. Further, if an operating system is assigned a computer system, INQUIRY 1634, the computer systems having the same associated CEC as the repelled operating system are removed from the target_candidate list, STEP 1636, and processing returns to STEP 1628. If, however, the resource does not appear in the list, INQUIRY 1630, or a subsystem is being assigned a target, INQUIRY 1634, processing returns to STEP 1628.

When all repel_candidate lists have been processed, the resource operation which is part of the “attrset” is assigned a target. Thus, processing continues at INQUIRY 1638, in which a determination is made as to whether an operating system is being assigned a target computer system. If so, and no target computer system associated with the same CEC is in the target_candidate list, INQUIRY 1644, an error is indicated and processing ends, in this example. Otherwise, for each computer system on the same CEC, STEP 1646, the BRMD of the target computer system is retrieved, STEP 1648. From the BRMD, the set of RS(s) associated with the computer system are determined, STEP 1650. Further, operation execution time averages for the required date/time range are formed, STEP 1652. In one example, this can be based on PSE(s) that match the requested date/time range. When all eligible target computer systems have been evaluated, INQUIRY 1646, the target having the smallest operation execution time is selected as the computer system target for the operating system, STEP 1654. Further, the target is removed from the list of operations requiring a target assignment, STEP 1656, and processing returns to STEP 1620 (FIG. 16A).

Returning to INQUIRY 1638 (FIG. 16B), if the resource being assigned a target is a subsystem, the same target is assigned, STEP 1658, and the resource is removed from the list of operations requiring a target assignment, STEP 1656. Processing then returns to STEP 1620 (FIG. 16A).

At STEP 1620, when all roots of the “attrset” graph have been processed, a determination is made regarding any target_candidate list(s) having become null, INQUIRY 1660 (FIG. 16C). If any target_candidate list has become null, an error is set before exiting, in this example. This concludes the description of one embodiment of processing to select a target for a given resource.

In the above selection logic, various examples of attracts and repels are provided. These are only examples. Additional, less and/or other examples may be provided. For instance, in another embodiment, an OS can be repelled from a particular computing system.

Selection from RG Based on Quality of Service Characteristics

Choice of a resource within the RG can also be prioritized based on performance and other quality of service characteristics for best choice from among the set of resources associated with the RG. For example, throughput, bandwidth, and response time criteria are three examples of criteria that may be used in further optimizing and extending the selection technique. Optimizing using additional quality of service characteristics in the selection criteria allows the RG to be even more dynamic in its ability to respond to changes in the environment.

### Delete RG

In one example, processing is provided to delete an existing RG from the environment managed by the BRM. In this example, the flow finds related BRMD and BRRD entries that have to be cleaned up to keep referential integrity in the data (and enforced by DB2). This flow is initiated from the UI, and processed after verifying the delete request.
Any BRMD entry that references the RG being deleted is updated.
Any BRRD that involves the RG is removed.
The RG table entry is deleted.
UI interaction on which RG is to be deleted.
Read RG table with id of RG to be deleted.
Start a transaction for DEL_RGTAB_ENTRY.
***find brmds that need to be updated, and brrds that need to be deleted****
Read BRRD selecting entries referencing the RG to be deleted.
For each BRRD row returned
   Read BRMD entry
      a. Update the BRMD entry to remove reference to RG_id
End for each BRRD
For each BRRD row returned
   Insert into the RS Activity log: information that is in the BRMD and BRRD for the pairing being deleted:
      a. What BRRD pairing rules content it has,
      b. Resource identifiers for the BRRD entry,
      c. What BRMD/RG/RS metadata was associated with each resource of the BRRD pair
   Delete BRRD entry
End for each BRRD
Delete RGTAB entry
INSERT BRM_Activity_LOG: RGTAB entry deleted, rgtab_entry_deleted, del_rg_entry, timestamp
Transaction COMMIT DEL_RGTAB_ENTRY

Described in detail above is the definition and use of Redundancy Groups in runtime management of business applications.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

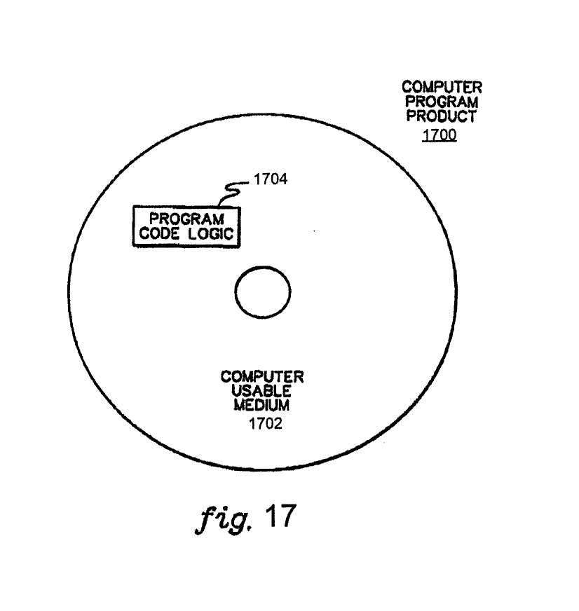

One example of an article of manufacture or a computer program product incorporating one or more aspects of the present invention is described with reference to FIG. 17. A computer program product 1700 includes, for instance, one or more computer usable media 1702 to store computer readable program code means or logic 1704 thereon to provide and facilitate one or more aspects of the present invention. The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, a random access memory (RAM), a read-only memory (ROM), a rigid magnetic disk and an optical disk. Examples of optical disks include compact disk-read only memory (CD-ROM), compact disk-read/write (CD-R/W) and DVD.

A sequence of program instructions or a logical assembly of one or more interrelated modules defined by one or more computer readable program code means or logic direct the performance of one or more aspects of the present invention.

Advantageously, a capability is provided for facilitating active management of business applications during runtime. Redundancy groups, each of which include functional equivalent resources, are employed in the reconfiguration of resources associated with a business application to meet desired goals, such as availability goals or other goals of the application.

Although various embodiments are described above, these are only examples. For example, the processing environments described herein are only examples of environments that may incorporate and use a Redundancy Group and/or one or more other aspects of the present invention. Environments may include other types of processing units or servers or the components in each processing environment may be different than described herein. Each processing environment may include additional, less and/or different components than described herein. Further, the types of central processing units and/or operating systems or other types of components may be different than described herein. Again, these are only provided as examples.

Moreover, an environment may include an emulator (e.g., software or other emulation mechanisms), in which a particular architecture or subset thereof is emulated. In such an environment, one or more emulation functions of the emulator can implement one or more aspects of the present invention, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to obtain instructions from memory and to optionally, provide local buffering for the obtained instruction; an instruction decode unit to receive the instruction fetched and to determine the type of instructions that have been fetched; and an instruction execution unit to execute the instructions. Execution may include loading data into a register for memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

Further, although the environments described herein are related to the management of availability of a customer's environment, one or more aspects of the present invention may be used to manage aspects other than or in addition to availability. Further, one or more aspects of the present invention can be used in environments other than a business resiliency environment.

Yet further, many examples are provided herein, and these examples may be revised without departing from the spirit of the present invention. For example, in one embodiment, the description is described in terms of availability and recovery; however, other goals and/or objectives may be specified in lieu of or in addition thereto. Additionally, the resources may be other than IT resources. Further, in the tables described herein, there may be references to particular products offered by International Business Machines Corporation or other companies. These again are only offered as examples, and other products may also be used. Additionally, although tables and databases are described herein, any suitable data structure may be used. There are many other variations that can be included in the description described herein and all of these variations are considered a part of the claimed invention.

Further, for completeness in describing one example of an environment in which a RG may be utilized, certain components and/or information is described that is not needed for one or more aspects of the present invention. These are not meant to limit the aspects of the present invention in any way.

The terms “obtaining” used herein includes, but is not limited to, creating, defining, building, forming, having, receiving, being provided, retrieving, etc.

One or more aspects of the present invention can be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider can receive payment from the customer under a subscription and/or fee agreement, as examples. Additionally or alternatively, the service provider can receive payment from the sale of advertising content to one or more third parties.

In one aspect of the present invention, an application can be deployed for performing one or more aspects of the present invention. As one example, the deploying of an application comprises providing computer infrastructure operable to perform one or more aspects of the present invention.

As a further aspect of the present invention, a computing infrastructure can be deployed comprising integrating computer readable code into a computing system, in which the code in combination with the computing system is capable of performing one or more aspects of the present invention.

As yet a further aspect of the present invention, a process for integrating computing infrastructure, comprising integrating computer readable code into a computer system may be provided. The computer system comprises a computer usable medium, in which the computer usable medium comprises one or more aspects of the present invention. The code in combination with the computer system is capable of performing one or more aspects of the present invention.

The capabilities of one or more aspects of the present invention can be implemented in software, firmware, hardware, or some combination thereof. At least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

Although embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A computer-implemented method to determine targets for operations, said computer-implemented method comprising:
obtaining a redundancy group, said redundancy group comprising one or more functionally equivalent resources of a particular type; and
dynamically evaluating, during runtime and in response to an occurrence of an event, which resource of a plurality of resources of the redundancy group is to be used as a target for an operation to be performed.

2. The computer-implemented method of claim 1, wherein the dynamically evaluating takes into consideration the event that has occurred and a state of an Information Technology (IT) runtime environment of which the redundancy group is included.

3. The computer-implemented method of claim 2, wherein the dynamically evaluating further takes into consideration one or more requirements for co-location or anti-co-location in selecting the target resource.

4. The computer-implemented method of claim 1, wherein the redundancy group has a state associated therewith, said state used to influence the availability of an Information Technology runtime environment of which the redundancy group is included.

5. The computer-implemented method of claim 1, wherein the dynamically evaluating selects multiple resources of the redundancy group to be used as targets for multiple operations to be performed, wherein the dynamically evaluating optimizes the selection such that there is a target for each operation of the multiple operations.

6. The computer-implemented method of claim 5, wherein the resource capable of accommodating a minimum number of operations is selected prior to the resource capable of accommodating more than the minimum number of operations.

7. The computer-implemented method of claim 5, wherein the dynamically evaluating is based on at least one of resources in a repel list, non-operational resources, already started resources, co-location requirements or anti-co-location requirements.

8. The computer-implemented method of claim 1, wherein the dynamically evaluating is based on quality of service characteristics of the resources of the redundancy group.

9. A system to determine targets for operations, said system comprising:
a memory comprising a redundancy group, said redundancy group comprising one or more functionally equivalent resources of a particular type; and
at least one processor coupled to the memory to dynamically evaluate, during runtime and in response to an occurrence of an event, which resource of a plurality of resources of the redundancy group is to be used as a target for an operation to be performed.

10. The system of claim 9, wherein the at least one processor to dynamically evaluate takes into consideration the event that has occurred and a state of an Information Technology runtime environment of which the redundancy group is included.

11. The system of claim 9, wherein the redundancy group has a state associated therewith, said state used to influence the availability of an Information Technology runtime environment of which the redundancy group is included.

12. The system of claim 9, wherein the at least one processor to dynamically evaluate selects multiple resources of the redundancy group to be used as targets for multiple operations to be performed, wherein the dynamically evaluating optimizes the selection such that there is a target for each operation of the multiple operations.

13. The system of claim 12, wherein the resource capable of accommodating a minimum number of operations is selected prior to the resource capable of accommodating more than the minimum number of operations.

14. The system of claim 9, wherein the dynamically evaluating is based on quality of service characteristics of the resources of the redundancy group.

15. An article of manufacture comprising:
at least one computer usable medium having computer readable program code logic to determine targets for operations, said computer readable program code logic when executing performing the following:
obtaining a redundancy group, said redundancy group comprising one or more functionally equivalent resources of a particular type; and
dynamically evaluating, during runtime and in response to an occurrence of an event, which resource of a plurality of resources of the redundancy group is to be used as a target for an operation to be performed.

16. The article of manufacture of claim 15, wherein the dynamically evaluating takes into consideration the event that has occurred and a state of an Information Technology runtime environment of which the redundancy group is included.

17. The article of manufacture of claim 16, wherein the dynamically evaluating further takes into consideration one or more requirements for co-location or anti-co-location in selecting the target resource.

18. The article of manufacture of claim 15, wherein the redundancy group has a state associated therewith, said state used to influence the availability of an Information Technology runtime environment of which the redundancy group is included.

19. The article of manufacture of claim 15, wherein the dynamically evaluating selects multiple resources of the redundancy group to be used as targets for multiple operations to be performed, wherein the dynamically evaluating optimizes the selection such that there is a target for each operation of the multiple operations.

20. The article of manufacture of claim 15, wherein the dynamically evaluating is based on quality of service characteristics of the resources of the redundancy group.
